(19) United States
(12) Patent Application Publication
(10) Pub. No.: US 2020/0057581 A1
(43) Pub. Date: Feb. 20, 2020

(54) MEMORY SYSTEM AND OPERATING METHOD THEREOF

(71) Applicant: SK hynix Inc., Gyeonggi-do (KR)

(72) Inventor: Hae-Gi CHOI, Gyeonggi-do (KR)

(21) Appl. No.: 16/382,340

(22) Filed: Apr. 12, 2019

(30) Foreign Application Priority Data
Aug. 17, 2018 (KR) 10-2018-0096000

(51) Int. Cl. G06F 3/06

(52) U.S. Cl. CPC G06F 3/0659; G06F 3/0679; G06F 3/0653; G06F 3/0611

(57) ABSTRACT

A memory system may include: a plurality of nonvolatile memory devices; a command queue suitable for storing a set number of commands received from a host; and a controller suitable for generating temperature information by checking temperatures of the respective nonvolatile memory devices at each set time, calculating rankings of the respective nonvolatile memory devices by using the temperature information, and scheduling an execution sequence of the commands stored in the command queue, based on the calculated rankings.

### CROSS-REFERENCE TO RELATED APPLICATION

This application claims priority under 35 U.S.C. § 119 to Korean Patent Application No. 10-2018-0096000, filed on Aug. 17, 2018, which is incorporated herein by reference in its entirety.

### BACKGROUND

### 1. Field

Various embodiments relate to a memory system and, more particularly, to a memory system including a plurality of nonvolatile memory devices.

### 2. Discussion of the Related Art

The computer environment paradigm has changed to ubiquitous computing systems that can be used anytime and anywhere. Due to this, use of portable electronic devices such as mobile phones, digital cameras, and notebook computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSDs).

### SUMMARY

Various embodiments are directed to a memory system capable of effectively scheduling commands received from a host and then transferring the commands to a plurality of nonvolatile memory devices included therein, and an operating method thereof.

In an embodiment, a memory system may include: a plurality of nonvolatile memory devices; a command queue suitable for storing a set number of commands received from a host; and a controller suitable for generating temperature information by checking temperatures of the respective nonvolatile memory devices at each set time, calculating rankings of the respective nonvolatile memory devices by using the temperature information, and scheduling an execution sequence of the commands stored in the command queue, based on the calculated rankings.

The set time may be any among a first time requested from the host, a second time repeated with a set time interval, a third time repeated each time a size of data transmitted by the controller to, or received by the controller from, the host is a set size, a fourth time repeated each time commands received by the controller from the host is a set number, and a fifth time at which an idle time of the controller is maintained for at least a set time.

Each of the nonvolatile memory devices may include a plurality of memory blocks, the controller may calculate rankings of the respective nonvolatile memory devices by using the temperature information and parameter information for the respective nonvolatile memory devices, and the parameter information may include at least one of information on the number of free blocks among the memory blocks in each of the nonvolatile memory devices, information on the number of bad blocks among the memory blocks, information on a read reclaim count accumulated based on the set time, information on a size of write data accumulated based on the set time, and information on a length of an idle time based on the set time.

The respective nonvolatile memory devices may include temperature measurement circuits for physically measuring temperatures thereof, and the controller may receive information on temperatures measured by the temperature measurement circuits of the respective nonvolatile memory devices at each set time, as the temperature information.

The controller may include a plurality of counters for counting the numbers of commands transferred to the respective nonvolatile memory devices, and may calculate temperatures expected in the respective nonvolatile memory devices, as the temperature information, by checking values of the respective counters at each set time, and then initializes the counters.

The controller may calculate an average temperature of the nonvolatile memory devices by checking the temperatures of the respective nonvolatile memory devices, may compare the calculated average temperature with the temperatures of the respective nonvolatile memory devices, and may determine the rankings of the respective nonvolatile memory devices depending on a result of the comparison.

The controller, in the case where the temperatures for at least two memory devices among the nonvolatile memory devices are within a set temperature range, may check the parameter information for the at least two memory devices, and may adjust rankings depending on a result of the check.

The controller, as a result of checking the parameter information for the at least two memory devices, may increase a ranking of a memory device of the at least two memory devices which is relatively larger in the number of free blocks, is relatively smaller in the number of bad blocks, is relatively smaller in a value of a read reclaim count accumulated based on the set time, is relatively smaller in a size of write data accumulated based on the set time or is relatively longer in a length of an idle time based on the set time.

The controller may schedule the execution sequence of the commands stored in the command queue such that a command corresponding to a nonvolatile memory device of which ranking is relatively high among the nonvolatile memory devices is executed before a command corresponding to a nonvolatile memory device of which ranking is relatively low among the nonvolatile memory devices.

The controller may schedule an execution sequence of write commands among the commands stored in the command queue such that a write command corresponding to a nonvolatile memory device of which ranking is relatively high among the nonvolatile memory devices is executed before a write command corresponding to an nonvolatile memory device of which ranking is relatively low among the nonvolatile memory devices.

In an embodiment, a method for operating a memory system including a plurality of nonvolatile memory devices and a command queue for storing a set number of commands received from a host, the method may include: generating temperature information by checking temperatures of the respective nonvolatile memory devices at each set time, using a controller; calculating rankings of the respective nonvolatile memory devices by using the temperature information, using the controller; and scheduling an execution sequence of the commands stored in the command queue, based on the calculated rankings of the nonvolatile memory devices, using the controller.

The set time may be any among a first time requested from the host, a second time repeated with a set time interval, a third time repeated each time a size of data transmitted by the controller to, or received by the controller from, the host is a set size, a fourth time repeated each time commands received by the controller from the host is a set number, and a fifth time at which an idle time of the controller is maintained for at least a set time.

Each of the nonvolatile memory devices may include a plurality of memory blocks, the method further may include managing, as parameter information, at least one of information on the number of free blocks among the memory blocks in each of the nonvolatile memory devices, information on the number of bad blocks among the memory blocks, information on a read reclaim count accumulated based on the set time, information on a size of write data accumulated based on the set time, and information on a length of an idle time based on the set time, and the calculating of the rankings of the respective nonvolatile memory devices may performed by using the temperature information and the parameter information.

The respective nonvolatile memory devices may include temperature measurement circuits for physically measuring temperatures thereof, and the generating of the temperature information comprises receiving temperatures measured by the temperature measurement circuits of the respective nonvolatile memory devices at each set time, as the temperature information.

The method may further include: counting, by a plurality of counters, the numbers of commands transferred to the respective nonvolatile memory devices. The generating of the temperature information may include calculating temperatures expected in the respective nonvolatile memory devices, as the temperature information, by checking values of the respective counters at each set time, and then initializing the counters.

The calculating of the rankings may include: calculating an average temperature of the nonvolatile memory devices by checking the generated temperatures; and adjusting a first ranking by comparing the average temperature calculated with the temperatures of the respective nonvolatile memory devices, and determining the rankings of the respective nonvolatile memory devices based on a result of the comparison.

The calculating of the rankings may include: adjusting a second ranking, in the case where at least two among the generated temperatures are within a set temperature range, by checking the parameter information for at least two nonvolatile memory devices corresponding to the at least two generated temperatures, and adjusting rankings depending on a result of the check.

The adjusting of the second ranking may include: in the case where at least two among the generated temperatures are within a set temperature range, checking the parameter information for at least two nonvolatile memory devices corresponding to the at least two generated temperatures; and increasing a ranking of a memory device of the at least two memory devices which is relatively larger in the number of free blocks, relatively smaller in the number of bad blocks, relatively smaller in a value of a read reclaim count accumulated based on the set time, relatively smaller in a size of write data accumulated based on the set time or being relatively longer in a length of an idle time based on the set time.

The scheduling of the execution sequence of the commands may include scheduling the execution sequence of the commands stored in the command queue such that a command corresponding to a nonvolatile memory device of which ranking is relatively high among the nonvolatile memory devices is executed before a command corresponding to a nonvolatile memory device of which ranking is relatively low among the nonvolatile memory devices.

The scheduling of the execution sequence of the commands may include scheduling an execution sequence of write commands among the commands stored in the command queue such that a write command corresponding to a nonvolatile memory device of which ranking is relatively high among the nonvolatile memory devices is executed before a write command corresponding to a nonvolatile memory device of which ranking is relatively low among the nonvolatile memory devices.

In an embodiment, a memory system may include: a plurality of memory devices, each of the memory devices including a temperature measurement circuit to measure temperature therein; and a controller configured to: store commands received from a host in a command queue; collect temperature information indicative of the measured temperatures from the memory devices; determine rankings of the memory devices relative to one another based on the temperature information and parameter information of the memory devices; and schedule execution of the stored commands based on the determined rankings.

In the present technology, respective operating conditions of a plurality of nonvolatile memory devices included in a memory system are checked, and an execution sequence of commands transferred from a host and stored in a command queue is scheduled depending on the checked operating conditions.

Through this, it is possible to improve the reliability and processing speed of data to be accessed to the memory system.

### BRIEF DESCRIPTION OF THE DRAWINGS

FIGS. 1 and 2 are diagrams illustrating a memory system including a plurality of nonvolatile memory devices in accordance with an embodiment of the present disclosure.

FIGS. 3 and 4 are diagrams illustrating an operation of a memory system, such as that illustrated in FIGS. 1 and 2, in accordance with an embodiment of the present disclosure.

FIGS. 5 and 6 are diagrams illustrating another operation of a memory system, such as that illustrated in FIGS. 1 and 2, in accordance with an embodiment of the present disclosure.

FIGS. 7, 8A and 8B are diagrams illustrating still another operation of a memory system, such as that illustrated in FIGS. 1 and 2, in accordance with an embodiment of the present disclosure.

FIG. 9 is a flow chart illustrating an operation of a memory system, such as that illustrated in FIGS. 1 and 2, in accordance with an embodiment of the present disclosure.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Throughout the disclosure, like reference numerals refer to like parts throughout the various figures and embodiments of the present invention. Also, throughout the specification, reference to “an embodiment,” “another embodiment” or the like is not necessarily to only one embodiment, and different references to any such phrase are not necessarily to the same embodiment(s).

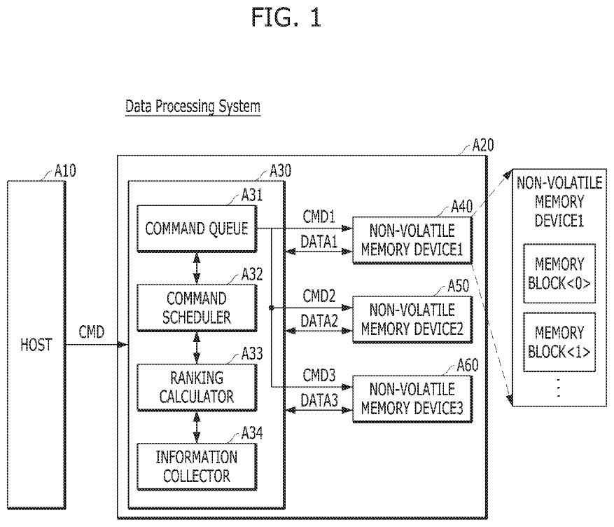

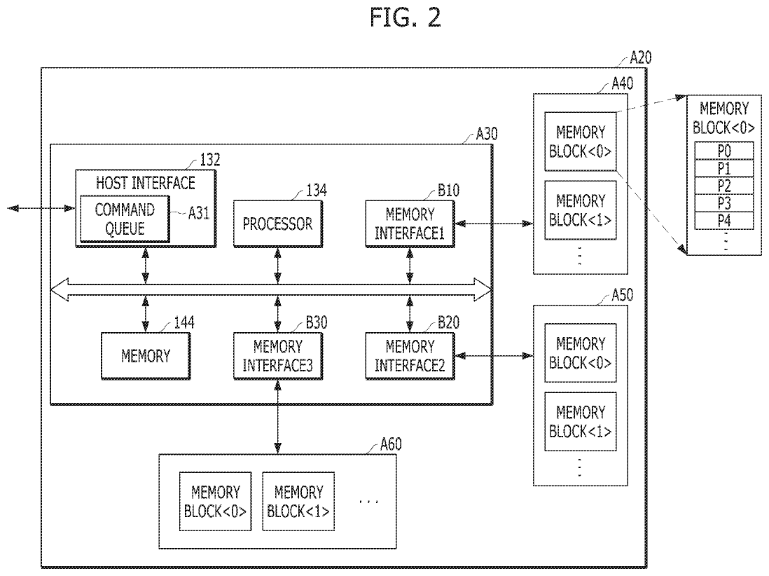

FIGS. 1 and 2 are diagrams illustrating a memory system including a plurality of nonvolatile memory devices in accordance with an embodiment of the present disclosure.

Referring to FIG. 1, a data processing system includes a host A10 and a memory system A20. The memory system A20 includes a controller A30, a first nonvolatile memory device A40, a second nonvolatile memory device A50 and a third nonvolatile memory device A60. Each of the nonvolatile memory devices A40, A50 and A60 includes a plurality of memory blocks MEMORY BLOCK<0, 1, 2, . . . >.

FIGS. 1 and 2 show, by way of example, that the memory system A20 includes three nonvolatile memory devices A40, A50 and A60, and embodiments of the present invention are described below in the context of that configuration. However, the present invention is not limited to that configuration; in another embodiment, more or less than three nonvolatile memory devices are included in a memory system. In general, the memory system A20 may include two or more nonvolatile memory devices.

The host A10 transmits a plurality of commands corresponding to a user request to the memory system A20. Accordingly, the memory system A20 performs operations corresponding to the commands, that is, operations corresponding to the user request.

The memory system A20 operates in response to a request of the host A10, in particular, stores data to be accessed by the host A10. In other words, the memory system A20 may be used as a main memory device or an auxiliary memory device of the host A10. The memory system A20 may be realized by any one of various kinds of storage devices, depending on a host interface protocol which is coupled with the host A10. For example, the memory system A20 may be realized by any one of various kinds of storage devices such as a solid state drive (SSD), a multimedia card in the form of an MMC, an embedded MMC (eMMC), a reduced size MMC (RS-MMC) and a micro-MMC, a secure digital card in the form of an SD, a mini-SD and a micro-SD, a universal serial bus (USB) storage device, a universal flash storage (UFS) device, a compact flash (CF) card, a smart media card, a memory stick, and the like.

The memory system A20 may be integrated into one semiconductor device to configure a memory card such as a Personal Computer Memory Card International Association (PCMCTA) card, a compact flash (CF) card, a smart media card in the form of an SM and an SMC, a memory stick, a multimedia card in the form of an MMC, an RS-MMC and a micro-MMC, a secure digital card in the form of an SD, a mini-SD, a micro-SD and an SDHC, and/or a universal flash storage (UFS) device.

In another embodiment, the memory system A20 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digitalcamera, a digital multimedia broadcasting (DMB) player, a 3- dimensional television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various component elements configuring a computing system.

The memory system A20 may include a storage device such as a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable and programmable ROM (EEPROM), an ferroelectric random access memory (FRAM), a phase change RAM (PRAM), a magnetic RAM (MRAM), a resistive RAM (RRAM or ReRAM) and a flash memory,

The controller A30 includes a command queue A31 for storing a set number of commands CMD received from the host A10.

The controller A30 may measure the temperatures of the respective nonvolatile memory devices A40, A50 and A60 at each set time. The controller A30 may ranking of the respective nonvolatile memory devices A40, A50 and A60 by using the temperatures measured in the respective nonvolatile memory devices A40, A50 and A60. To this end, the controller A30 further includes an information collector A34 and a ranking calculator A33. The information collector A34 collects temperature information of the respective nonvolatile memory devices A40, A50 and A60. The ranking calculator A33 calculates the rankings of the respective nonvolatile memory devices A40, A50 and A60 by using the temperature information of the respective nonvolatile memory devices A40, A50 and A60 collected by the information collector A34.

The controller A30 schedules the execution sequence of the commands CMD stored in the command queue A31, based on the rankings calculated for the respective nonvolatile memory devices A40, A50 and A60. To this end, the controller A30 further includes a command scheduler A32 for scheduling the execution sequence of the commands CMD stored in the command queue A31, depending on the rankings of the respective nonvolatile memory devices A40, A50 and A60.

The controller A30 calculates the rankings of the respective nonvolatile memory devices A40, A50 and A60 by using not only the temperature information for the respective nonvolatile memory devices A40, A50 and A60 but also parameter information for the respective nonvolatile memory devices A40, A50 and A60.

That is to say, the controller A30 may calculate the rankings of the respective nonvolatile memory devices A40, A50 and A60 by using only the temperatures measured in the respective nonvolatile memory devices A40, A50 and A60 at each set time. Alternatively, the controller A30 may calculate the rankings of the respective nonvolatile memory devices A40, A50 and A60 by using the temperature information and the parameter information for the respective nonvolatile memory devices A40, A50 and A60.

The set time may be a first time that is requested to the controller A30 of the memory system A20 from the host A10.

The set time may be a second time that is repeated at a set frequency or a set time interval in the controller A30 of the memory system A20.

The set time may be a third time that is repeated each time the size of data inputted/outputted between the controller A30 of the memory system A20 and the host A10 becomes a set size. In other words, the controller A30 may check how large the size of data inputted/outputted between the controller A30 and the host A10 is, and may determine, as the third time, a time when the size becomes the set size.

The set time may be a fourth time that is repeated each time the commands CMD transferred from the host A10 to the controller A30 of the memory system A20 reaches a set number. In other words, the controller A30 may count the number of the commands CMD transferred from the host A10, and may determine, as the fourth time, a time when the counted number becomes the set number.

The set time may be a fifth time at which it is determined that an idle time is maintained in the controller A30 of the memory system A20 for at least a set time. In other words, the controller A30 may determine the length of an idle period in which no operation request is generated from the host A10, and may determine, as the fifth time, a time at which the determine time exceeds the set time.

As described above, the set time may be the first time that is requested to the controller A30 of the memory system A20 from the host A10, the second time that is repeated with a set time interval in the controller A30 of the memory system A20, the third time that is repeated each time the size of data inputted/outputted between the controller A30 of the memory system A20 and the host A10 becomes a set size, the fourth time that is repeated each time the commands CMD transferred from the host A10 to the controller A30 of the memory system A20 reaches a set number, and the fifth time at which it is determined that an idle time is maintained in the controller A30 for at least a set time.

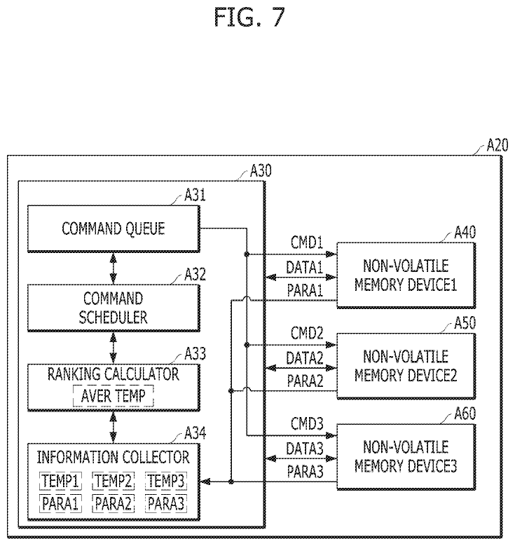

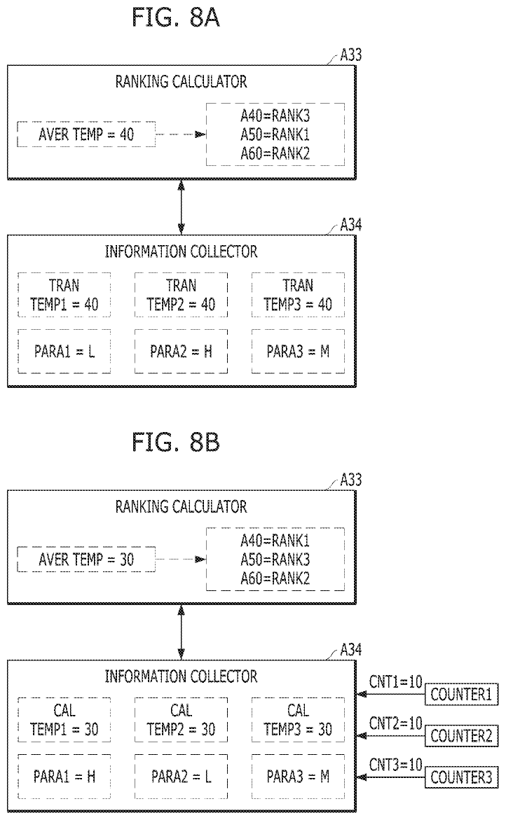

Each of parameter information PARA1, PARA2 and PARA3 (see FIGS. 7, 8A and 8B) of the respective nonvolatile memory devices A40, A50 and A60 may include information on the number of free blocks among the plurality of memory blocks, e.g., MEMORY BLOCK<0, 1, 2, . . . > included in each of the nonvolatile memory devices A40, A50 and A60.

Each of the parameter information PARA1, PARA2 and PARA3 of the respective nonvolatile memory devices A40, A50 and A60 may include information on the number of bad blocks among the plurality of memory blocks MEMORY BLOCK<0, 1, 2, . . . > included in each of the nonvolatile memory devices A40, A50 and A60.

Each of the parameter information PARA1, PARA2 and PARA3 of the respective nonvolatile memory devices A40, A50 and A60 may include information on a read reclaim count accumulated in each of the nonvolatile memory devices A40, A50 and A60 based on the set time. Namely, each of the parameter information PARA1, PARA2 and PARA3 of the respective nonvolatile memory devices A40, A50 and A60 may include information on the number of a read reclaims that have accumulated in each of the nonvolatile memory devices A40, A50 and A60 from a first set time to a second set time.

Each of the parameter information PARA1, PARA2 and PARA3 of the respective nonvolatile memory devices A40, A50 and A60 may include information on the size of write data accumulated in each of the nonvolatile memory devices A40, A50 and A60 based on the set time. Namely, each of the parameter information PARA1, PARA2 and PARA3 of the respective nonvolatile memory devices A40, A50 and A60 may include information on the size of write data accumulated in each of the nonvolatile memory devices A40, A50 and A60 from a first set time to a second set time.

Each of the parameter information PARA1, PARA2 and PARA3 of the respective nonvolatile memory devices A40, A50 and A60 may include information on the length of an idle time in each of the nonvolatile memory devices A40, A50 and A60 based on the set time. Namely, each of the parameter information PARA1, PARA2 and PARA3 of the respective nonvolatile memory devices A40, A50 and A60 may include information on how long the length of an idle time in each of the nonvolatile memory devices A40, A50 and A60 from a first set time to a second set time is.

As described above, each of the parameter information PARA1, PARA2 and PARA3 of the respective nonvolatile memory devices A40, A50 and A60 may include at least one of the number of free blocks among the plurality of memory blocks MEMORY BLOCK<0, 1, 2, . . . > included in each of the nonvolatile memory devices A40, A50 and A60, the information on the number of bad blocks among the plurality of memory blocks MEMORY BLOCK<0, 1, 2, . . . > included in each of the nonvolatile memory devices A40, A50 and A60, the information on a read reclaim count accumulated in each of the nonvolatile memory devices A40, A50 and A60 based on the set time, the information on the size of write data accumulated in each of the nonvolatile memory devices A40, A50 and A60 based on the set time, and the information on the length of an idle time in each of the nonvolatile memory devices A40, A50 and A60 based on the set time.

Referring to FIG. 2, the detailed configuration of the memory system A20 described above with reference to FIG. 1 may be seen.

The controller A30 included in the memory system A20 controls the first to third nonvolatile memory devices A40, A50 and A60 in response to a request from the host A10. For example, the controller A30 provides data read from the first to third nonvolatile memory devices A40, A50 and A60, to the host A10, and stores data provided from the host A10, in the first to third nonvolatile memory devices A40, A50 and A60. To this end, the controller A30 controls the operations of the first to third nonvolatile memory devices A40, A50 and A60, such as read, write, program and erase operations.

In detail, the controller A30 includes a host interface (HOST INTERFACE) 132, a processor (PROCESSOR) 134, a memory 144, a first memory interface (MEMORY INTERFACE1) B10, a second memory interface (MEMORY INTERFACE2) B20 and a third memory interface (MEMORY INTERFACE3) B30.

The host interface 132 performs an operation of exchanging commands CMD and data with the host A10. Thus, the command queue A31 for storing a set number of commands CMD transferred from the host A10, which is described above with reference to FIG. 1, may be included in the host interface 132.

The commands CMD transferred from the host A10 may include a plurality of commands CMD with the same characteristic that are successively transferred. Alternatively, commands CMD with different characteristics may be transferred in a mixed sequence. For example, a plurality of read commands for reading data may be transferred, or read and program commands may be alternately transferred. Therefore, the host interface 132 includes therein the command queue A31, and stores the commands CMD transferred from the host A10, in a set sequence. Thereafter, depending on the characteristics of the commands CMD which are transferred from the host A10 and are stored in the command queue A31, it is possible to predict which operation the controller A30 will perform, and, based on this, it is possible to determine the processing sequence or priorities of the commands CMD stored in the command queue A31.

The host interface 132 may be configured to communicate with the host A10 through at least one of various interface protocols such as universal serial bus (USB), multimedia card (MMC), peripheral component interconnect express (PCI-e or PCIe), serial attached SCSI (SAS), serial advanced technology attachment (SATA), parallel advanced technology attachment (PATA), small computer system interface (SCSI), enhanced small disk interface (ESDI), integrated drive electronics (IDE) and MIPI (mobile industry processor interface). The host interface 132 may be driven through firmware which is referred to as a host interface layer (HIL), which is a region that exchanges data with the host A10.

The first to third memory interfaces B10, B20 and B30 serve as memory/storage interfaces which perform interfacing between the controller A30 and the first to third nonvolatile memory devices A40, A50 and A60, to allow the controller A30 to control the respective first to third nonvolatile memory devices A40, A50 and A60 in response to a request from the host A10. Each of the first to third memory interfaces B10, B20 and B30 generates control signals for controlling each of the first to third nonvolatile memory devices A40, A50 and A60 and processes data under the control of the processor 134, as a NAND flash controller (NFC) in the case where each of the first to third nonvolatile memory devices A40, A50 and A60 is a flash memory, in particular, a NAND flash memory.

Each of the first to third memory interfaces B10, B20 and B30 may support the operation of an interface which processes a command and data between the controller A30 and each of the first to third nonvolatile memory devices A40, A50 and A60, for example, a NAND flash interface. In particular, each of the first to third memory interfaces B10, B20 and B30 may support data input/output between the controller A30 and each of the first to third nonvolatile memory devices A40, A50 and A60. Each of the first to third memory interfaces B10, 320 and 330 may be driven through firmware which is referred to as a flash interface layer (FIL), which is a region that exchanges data with each of the first to third nonvolatile memory devices A40, A50 and A60.

The memory 144 operating as the working memory of the memory system A20 and the controller A30 stores data for driving of the memory system A20 and the controller A30. In detail, the memory 144 temporarily stores data which should be managed, when the controller A30 controls the first to third nonvolatile memory devices A40, A50 and A60 in response to a request from the host A10, for example, when the controller A30 controls the operations of the first to third nonvolatile memory devices A40, A50 and A60, such as read, write, program and erase operations.

The memory 144 may be realized by a volatile memory. For example, the memory 144 may be realized by a static random access memory (SRAM) or a dynamic random access memory (DRAM).

The memory 144 may be disposed inside the controller A30 as illustrated in FIG. 2. In another embodiment, the memory 144 may be disposed outside the controller A30. In the case where the memory 144 is disposed outside the controller A30 unlike the illustration of FIG. 2, the memory 144 should be realized by an external volatile memory to and from which data are inputted and outputted from and to the controller A30 through a separate memory interface (not shown).

The memory 144 stores data which should be managed in the course of controlling the operations of the first to third nonvolatile memory devices A40, A50 and A60. For such data storage, the memory 144 may include a program memory, a data memory, a write buffer/cache, a read buffer/cache, a data buffer/cache, a map buffer/cache, and so forth.

The processor 134 controls the entire operations of the controller A30. In particular, the processor 134 controls a program operation or a read operation for the first to third nonvolatile memory devices A40, A50 and A60, in response to a write request or a read request from the host A10. The processor 134 drives a firmware which is referred to as a flash translation layer (FTL), to control general operations of the controller A30 for the first to third nonvolatile memory devices A40, A50 and A60. The processor 134 may be realized by a microprocessor or a central processing unit (CPU).

For instance, the controller A30 performs an operation requested from the host A10, in the first to third nonvolatile memory devices A40, A50 and A60. That is, the controller A30 performs a command operation corresponding to a command received from the host A10, with the first to third nonvolatile memory devices A40, A50 and A60, through the processor 134 which is realized by a microprocessor or a central processing unit (CPU). The controller A30 may perform a foreground operation as a command operation corresponding to a command received from the host A10. For example, the controller A30 may perform a program operation corresponding to a write command, a read operation corresponding to a read command, an erase operation corresponding to an erase command or a parameter set operation corresponding to a set parameter command or a set feature command as a set command.

The controller A30 may perform a background operation for the first to third nonvolatile memory devices A40, A50 and A60, through the processor 134 which is realized by a microprocessor or a central processing unit (CPU). The background operation for the first to third nonvolatile memory devices A40, A50 and A60 may include a garbage collection (GC) operation of copying data stored in a certain memory block among memory blocks MEMORY BLOCK<0, 1, 2, . . . > of each of the first to third nonvolatile memory devices A40, A50 and A60, to another certain memory block. The background operation for the first to third nonvolatile memory devices A40, A50 and A60 may include a wear leveling (WL) operation of swapping stored data among the memory blocks MEMORY BLOCK<0, 1, 2, . . . > of each of the first to third nonvolatile memory devices A40, A50 and A60. The background operation for the first to third nonvolatile memory devices A40, A50 and A60 may include a map flush operation of storing map data stored in the controller A30, in the memory blocks MEMORY BLOCK<0, 1, 2, . . . > of each of the first to third nonvolatile memory devices A40, A50 and A60. The background operation for the first to third nonvolatile memory devices A40, A50 and A60 may include a bad management operation for the first to third nonvolatile memory devices A40, A50 and A60, which may include checking and processing a bad block among the plurality of memory blocks MEMORY BLOCK<0, 1, 2, . . . > included in each of the first to third nonvolatile memory devices A40, A50 and A60.

The controller A30 may generate and manage log data in correspondence to an operation of accessing the memory blocks MEMORY BLOCK<0, 1, 2, . . . > of each of the first to third nonvolatile memory devices A40, A50 and A60, through the processor 134 which is realized by a microprocessor or a central processing unit (CPU). The operation of accessing the memory blocks MEMORY BLOCK<0, 1, 2, . . . > of each of the first to third nonvolatile memory devices A40, A50 and A60 includes performing of a foreground operation or a background operation for the memory blocks MEMORY BLOCK<0, 1, 2, . . . > of each of the first to third nonvolatile memory devices A40, A50 and A60.

The processor 134 of the controller A30 may include a unit (not shown) for performing bad management of the first to third nonvolatile memory devices A40, A50 and A60. The unit for performing bad management of the first to third nonvolatile memory devices A40, A50 and A60 performs a bad block management of checking a bad block among the plurality of memory blocks MEMORY BLOCK<0, 1, 2, . . . > included in each of the first to third nonvolatile memory devices A40, A50 and A60 and processing the checked bad block as bad. The bad block management means that, in the case where each of the first to third nonvolatile memory devices A40, A50 and A60 is a flash memory (for example, a NAND flash memory), due to the characteristic of the NAND flash memory, a memory block where the program failure has occurred is processed as bad, and program-failed data is written (or programmed) in a new memory block. The program failure may occur when writing or programming data.

The controller A30 performs an operation of transmitting a command and data to be inputted/outputted between the controller A30 and the first to third nonvolatile memory devices A40, A50 and A60, through the processor 134. The processor 134 is realized by a microprocessor or a central processing unit (CPU). The command and data to be inputted/outputted between the controller A30 and the first to third nonvolatile memory devices A40, A50 and A60 may be transmitted from the host A10 to the controller A30 or may be generated inside the controller A30.

The controller A30 performs various operations depending on the rankings calculated for the respective nonvolatile memory devices A40, A50 and A60, through the processor 134, the first to third memory interfaces B10, B20 and B30 and the memory 144 described above. The various operations include the operation of the information collector A34 which measures the temperatures of the respective nonvolatile memory devices A40, A50 and A60 at each set time, the operation of the ranking calculator A33 which calculates the rankings of the respective nonvolatile memory devices A40, A50 and A60 by using the temperatures measured in the respective nonvolatile memory devices A40, A50 and A60, and the operation of the command scheduler A32 which schedules the execution sequence of the commands CMD stored in the command queue A31, depending on the rankings calculated for the respective nonvolatile memory devices A40, A50 and A60.

In other words, the information collector A34, the ranking calculator A33 and the command scheduler A32 included in the controller A30 may be regarded as components which are distinguished from one another by the logical operations of the controller A30. Such logical operations may be realized by the host interface 132, the processor 134, the memory 144 and the first to third memory interfaces B10, B20 and B30 as physical components as shown in FIG. 2.

Each of the first to third nonvolatile memory devices A40, A50 and A60 may retain stored data even though power is not supplied. In particular, each of the first to third nonvolatile memory devices A40, A50 and A60 may store write data WDATA provided from the host A10, through a write operation, and may provide read data (not shown) stored therein, to the host A10, through a read operation.

Each of the first to third nonvolatile memory devices A40, A50 and A60 may be realized by a nonvolatile memory such as a flash memory, for example, a NAND flash memory. Alternatively, each of the first to third nonvolatile memory devices A40, A50 and A60 may be realized by any of a phase change memory (PCRAM: phase change random access memory (PCRAM), a resistive random access memory (RRAM or ReRAM), a ferroelectric random access memory (FRAM) and a spin transfer torque magnetic random access memory (STT-RAM or STT-MRAM).

Each of the first to third nonvolatile memory devices A40, A50 and A60 includes the plurality of memory blocks MEMORY BLOCK<0, 1, 2, . . . >. In other words, each of the first to third nonvolatile memory devices A40, A50 and A60 may store write data WDATA provided from the host A10, in the memory blocks MEMORY BLOCK<0, 1, 2, . . . >, through a write operation. Also, each of the first to third nonvolatile memory devices A40, A50 and A60 may provide read data (not shown) stored in the memory blocks MEMORY BLOCK<0, 1, 2, . . . >, to the host A10, through a read operation.

Each of the memory blocks MEMORY BLOCK<0, 1, 2, . . . > included in each of the first to third nonvolatile memory devices A40, A50 and A60 includes a plurality of pages P<0, 1, 2, 3, 4, . . . >. Also, while not shown in detail in the drawing, each of the pages P<0, 1, 2, 3, 4, . . . > includes a plurality of memory cells.

Each of the memory blocks MEMORY BLOCK<0, 1, 2, . . . > included in the second nonvolatile memory device A50 may be a single level cell (SLC) memory block or a multi-level cell (MLC) memory block, depending on the number of bits which may be stored or expressed in one memory cell included therein. An SLC memory block includes a plurality of pages which are realized by memory cells each storing 1 bit, and has excellent data computation performance and high durability. An MLC memory block includes a plurality of pages which are realized by memory cells each storing multi-bit data (for example, 2 or more bits), and may be more highly integrated than the SLC memory block since it has a larger data storage space than the SLC memory block.

In particular, the MLC memory block may be an MLC memory block including a plurality of pages which are realized by memory cells each capable of storing 2-bit data, a triple level cell (TLC) memory block including a plurality of pages which are realized by memory cells each capable of storing 3-bit data, a quadruple level cell (QLC) memory block including a plurality of pages which are realized by memory cells each capable of storing 4-bit data or a multiple level cell memory block including a plurality of pages which are realized by memory cells each capable of storing 5 or more-bit data.

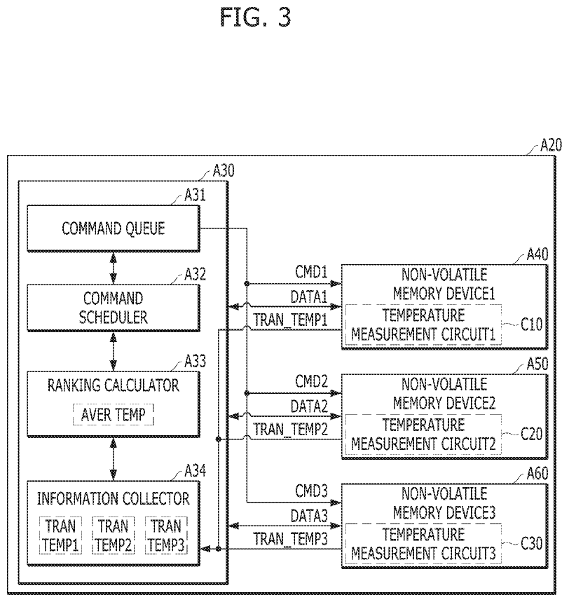

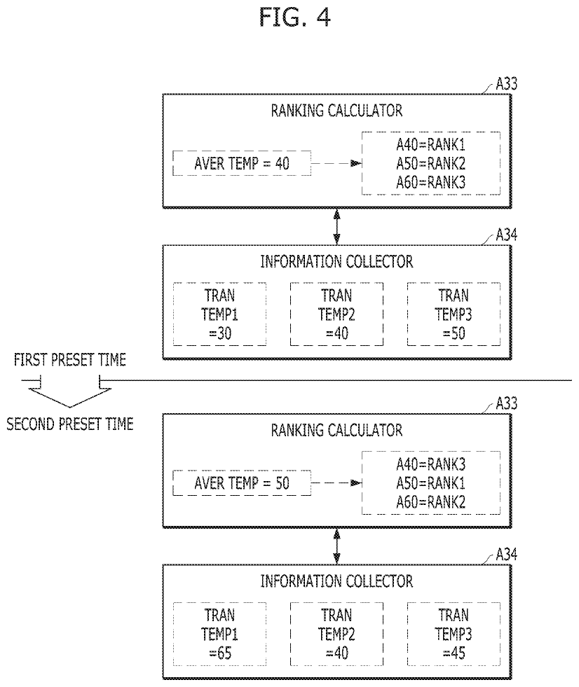

FIGS. 3 and 4 are diagrams illustrating an operation of the memory system A20 illustrated in FIGS. 1 and 2 in accordance with an embodiment of the present disclosure.

Referring to FIG. 3, the plurality of nonvolatile memory devices A40, A50 and A60 included in the memory system A20 respectively include temperature measurement circuits C10, C20 and C30 for physically measuring the temperatures thereof.

A first temperature measurement circuit C10 is included in the first nonvolatile memory device A40. A second temperature measurement circuit C20 is included in the second nonvolatile memory device A50. A third temperature measurement circuit C30 is included in the third nonvolatile memory device A60.

The first temperature measurement circuit C10 physically measures the temperature of the first nonvolatile memory device A40 and generates a first measurement value TRAN_TEMP1 based on the measurement result.

The second temperature measurement circuit C20 physically measures the temperature of the second nonvolatile memory device A50 and generates a second measurement value TRAN_TEMP2 based on the measurement result.

The third temperature measurement circuit C30 physically measures the temperature of the third nonvolatile memory device A60 and generates a third measurement value TRAN_TEMP3 based on the measurement result.

In this way, the first to third nonvolatile memory devices A40, A50 and A60 respectively include therein the temperature measurement circuits C10, C20 and C30 for physically measuring temperatures. The measurement values TRAN_TEMP1, TRAN_TEMP2 and TRAN_TEMP3 of the temperature measurement circuits C10, C20 and C30 are transferred to the information collector A34 included in the controller A30, by a request of the controller A30, at each set time.

For reference, each of the temperature measurement circuits C10, C20 and C30 may perform an operation of measuring temperature through a separate physical circuit or may perform an operation of computing a temperature through a specific operation predefined internally. In the case where the respective temperature measurement circuits C10, C20 and C30 perform operations of measuring temperatures in the respective first to third nonvolatile memory devices A40, A50 and A60 and transferring the measurement values TRAN_TEMP1, TRAN_TEMP2 and TRAN_TEMP3 to the controller A30, the specifics of the structure of, or operation performed by, each of the temperature measurement circuits C10, C20 and C30 may be realized in different ways depending on a designer's choice.

In detail, at each set time, the information collector A34 included in the controller A30 receives the first measurement value TRAN_TEMP1 from the first temperature measurement circuit C10 in the first nonvolatile memory device A40, receives the second measurement value TRAN_TEMP2 from the second temperature measurement circuit C20 in the second nonvolatile memory device A50, and receives the third measurement value TRAN_TEMP3 from the third temperature measurement circuit C30 in the third nonvolatile memory device A60.

The ranking calculator A33 included in the controller A30 calculates an average value AVER TEMP of the first to third measurement values TRAN_TEMP1, TRAN_TEMP2 and TRAN_TEMP3 transferred to the information collector A34, which may be a running average. That is, the ranking calculator A33 calculates and maintains the average temperature of the first to third nonvolatile memory devices A40, A50 and A60.

The ranking calculator A33 compares the calculated average value AVER TEMP with the first to third measurement values TRAN_TEMP1, TRAN_TEMP2 and TRAN_TEMP3 transferred to the information collector A34. In other words, the ranking calculator A33 compares the temperatures respectively measured in the first to third nonvolatile memory devices A40, A50 and A60, with the average temperature of the entire first to third nonvolatile memory devices A40, A50 and A60.

Depending on a comparison result, the ranking calculator A33 determines the rankings of the respective first to third nonvolatile memory devices A40, A50 and A60.

For example, the ranking calculator A33 lowers the ranking of a nonvolatile memory device for which the measured temperature is greater than the average value AVER TEMP relative to the ranking of a nonvolatile memory device corresponding for which the measured temperature is less than the average value AVER TEMP. In other words, the ranking calculator A33 lowers the ranking of a nonvolatile memory device having a temperature greater than the average temperature among the nonvolatile memory devices A40, A50 and A60, to be lower than the ranking of a nonvolatile memory device having a temperature less than the average temperature.

The command scheduler A32 included in the controller A30 schedules the execution sequence of the commands CMD stored in the command queue A31, depending on the rankings calculated in the ranking calculator A33.

In this regard, the command scheduler A32 may schedule an execution sequence for all kinds of the commands CMD stored in the command queue A31 or may schedule an execution sequence for only write commands among the commands CMD stored in the command queue A31.

A case where the command scheduler A32 schedules an execution sequence for all kinds of the commands CMD stored in the command queue A31 may be regarded as a first embodiment.

A case where the command scheduler A32 schedules an execution sequence for only write commands among the commands CMD stored in the command queue A31 may be regarded as a second embodiment.

The command scheduler A32 in accordance with an embodiment schedules the execution sequence of the commands CMD stored in the command queue A31 such that a command corresponding to a nonvolatile memory device of which ranking is relatively high among the first to third nonvolatile memory devices A40, A50 and A60 may be executed relatively earlier. Conversely, the command scheduler A32 in accordance with this embodiment schedules the execution sequence of the commands CMD stored in the command queue A31 such that a command corresponding to a nonvolatile memory device of which ranking is relatively low among the first to third nonvolatile memory devices A40, A50 and A60 may be executed relatively later.

The command scheduler A32 in accordance with another embodiment schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier. Conversely, the command scheduler A32 in accordance with this embodiment schedules the execution sequence of write commands among the commands CMD stored in the command queue A31 such that a write command corresponding to a nonvolatile memory device of which ranking is relatively low among the first to third nonvolatile memory devices A40, A50 and A60 may be executed relatively later.

For reference, the reason why the operation of the command scheduler A32 is classified into the different embodiments described above is because temperatures may rise to the highest extent when the nonvolatile memory devices A40, A50 and A60 perform program operations in response to write commands.

Referring to FIG. 4, an example is described in which, among measurement values transferred to the information collector A34 at a first set time, the first measurement value TRAN_TEMP1 is 30, the second measurement value TRAN_TEMP2 is 40 and the third measurement value TRAN_TEMP3 is 50.

In detail, the controller A30 requests, at the first set time, a value corresponding to the physically measured temperature of the first nonvolatile memory device A40, to the first temperature measurement circuit C10 in the first nonvolatile memory device A40. Accordingly, the first temperature measurement circuit C10 transfers the value of 30, obtained by physically measuring the temperature of the first nonvolatile memory device A40, to the controller A30. The information collector A34 in the controller A30 manages the value of 30 transferred from the first nonvolatile memory device A40, as the first measurement value TRAN_TEMP1.

The controller A30 requests, at the first set time, a value corresponding to the physically measured temperature of the second nonvolatile memory device A50, to the second temperature measurement circuit C20 in the second nonvolatile memory device A50. Accordingly, the second temperature measurement circuit C20 transfers the value of 40, obtained by physically measuring the temperature of the second nonvolatile memory device A50, to the controller A30. The information collector A34 in the controller A30 manages the value of 40 transferred from the second nonvolatile memory device A50, as the second measurement value TRAN_TEMP2.

The controller A30 requests, at the first set time, a value corresponding to the physically measured temperature of the third nonvolatile memory device A60, to the third temperature measurement circuit C30 in the third nonvolatile memory device A60. Accordingly, the third temperature measurement circuit C30 transfers the value of 50, obtained by physically measuring the temperature of the third nonvolatile memory device A60, to the controller A30. The information collector A34 in the controller A30 manages the value of 50 transferred from the third nonvolatile memory device A60, as the third measurement value TRAN_TEMP3.

Therefore, at the first set time, the information collector A34 in the controller A30 manages the first measurement value TRAN_TEMP1 which has the value of 30 transferred from the first temperature measurement circuit C10, the second measurement value TRAN_TEMP2 which has the value of 40 transferred from the second temperature measurement circuit C20 and the third measurement value TRAN_TEMP3 which has the value of 50 transferred from the third temperature measurement circuit C30.

In this state, the ranking calculator A33 calculates that the average value AVER TEMP of the first to third measurement values TRAN_TEMP1, TRAN_TEMP2 and TRAN_TEMP3 transferred to the information collector A34. In this example, the average value AVER TEMP of TRAN_TEMP1 having the value of 30, TRAN_TEMP2 having the value of 40 and TRAN_TEMP3 having the value of 50, is 40.

The ranking calculator A33 compares the calculated average value AVER TEMP of 40 with the respective first to third measurement values TRAN_TEMP1, TRAN_TEMP2 and TRAN_TEMP3, and calculates the rankings of the first to third nonvolatile memory devices A40, A50 and A60.

In detail, the ranking calculator A33 compares the first measurement value TRAN_TEMP1 of 30 with the calculated average value AVER TEMP of 40, and checks that the first measurement value TRAN_TEMP1 is less by 10 than the average value AVER TEMP. The ranking calculator A33 compares the second measurement value TRAN_TEMP2 of 40 with the calculated average value AVER TEMP of 40, and checks that the second measurement value TRAN_TEMP2 is equal to the average value AVER TEMP. The ranking calculator A33 compares the third measurement value TRAN_TEMP3 of 50 with the calculated average value AVER TEMP of 40, and checks that the third measurement value TRAN_TEMP3 is greater by 10 than the average value AVER TEMP.

After comparing the calculated average value AVER TEMP of 40 with the respective first to third measurement values TRAN_TEMP1, TRAN_TEMP2 and TRAN_TEMP3 in this way, the ranking calculator A33 may determine the rankings of the nonvolatile memory devices A40, A50 and A60. The ranking calculator A33 may determine the first nonvolatile memory device A40 corresponding to the first measurement value TRAN_TEMP1, which is less than the calculated average value AVER TEMP, as a first ranking RANK1. The ranking calculator A33 may determine the second nonvolatile memory device A50 corresponding to the second measurement value TRAN_TEMP2, which is equal to the calculated average value AVER TEMP, as a second ranking RANK2. The ranking calculator A33 may determine the third nonvolatile memory device A60 corresponding to the third measurement value TRAN_TEMP3, which is greater than the calculated average value AVER TEMP, as a third ranking RANK3.

Summarizing the above description, at the first set time, the ranking calculator A33 may determine the first nonvolatile memory device A40 as the first ranking RANK1, determine the second nonvolatile memory device A50 as the second ranking RANK2 and determine the third nonvolatile memory device A60 as the third ranking RANKS, by using the first to third measurement values TRAN_TEMP1, TRAN_TEMP2 and TRAN_TEMP3 collected in the information collector A34.

After the rankings of the respective first to third nonvolatile memory devices A40, A50 and A60 are determined, the command scheduler A32 in accordance with an embodiment schedules the execution sequence of the commands CMD stored in the command queue A31 such that a command corresponding to a nonvolatile memory device of which ranking is relatively high among the first to third nonvolatile memory devices A40, A50 and A60 may be executed relatively earlier than commands from the other nonvolatile memory devices.

Thus, the command scheduler A32 in accordance with this embodiment schedules a command corresponding to the first nonvolatile memory device A40, which has the highest or first ranking RANK1 among the first to third nonvolatile memory devices A40, A50 and A60, to be performed with a highest priority. Also, the command scheduler A32 schedules a command corresponding to the third nonvolatile memory device A60, which has the lowest or third ranking RANK3, to be performed with a lowest priority. Furthermore, the command scheduler A32 schedules a command corresponding to the second nonvolatile memory device A50, which has the middle or second ranking RANK2, to be performed with a middle priority.

If the execution sequence of the commands CMD stored in the command queue A31 is scheduled by the command scheduler A32 at the first set time in this way, a command operation for the first nonvolatile memory device A40 of the first/highest ranking RANK1 may be executed more frequently than a command operation for the second nonvolatile memory device A50 of the second/middle ranking RANK2. Therefore, after the first set time, a probability that the temperature of the first nonvolatile memory device A40 of the first/highest ranking RANK1 rises may be greater than a probability that the temperature of the second nonvolatile memory device A50 of the second/middle ranking RANK2 rises.

Similarly, if the execution sequence of the commands CMD stored in the command queue A31 is scheduled by the command scheduler A32 at the first set time, a command operation for the second nonvolatile memory device A50 of the second/middle ranking RANK2 may be executed more frequently than a command operation for the third nonvolatile memory device A60 of the third/lowest ranking RANK3 at the first set time. Therefore, after the first set time, a probability that the temperature of the second nonvolatile memory device A50 of the second/middle ranking RANK2 rises may be greater than a probability that the temperature of the third nonvolatile memory device A60 of the third/lowest ranking RANK3 rises.

After the rankings of the respective first to third nonvolatile memory devices A40, A50 and A60 are determined, the command scheduler A32 in accordance with another embodiment schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier than write commands from the other nonvolatile memory devices.

Thus, the command scheduler A32 schedules a write command corresponding to the first nonvolatile memory device A40 which has a highest ranking by being determined as the first ranking RANK1 among the first to third nonvolatile memory devices A40, A50 and A60, to be performed with a highest priority. Also, the command scheduler A32 schedules a write command corresponding to the third nonvolatile memory device A60 which has a lowest ranking by being determined as the third ranking RANK3, to be performed with a lowest priority. Furthermore, the command scheduler A32 schedules a write command corresponding to the second nonvolatile memory device A50 which has a middle ranking by being determined as the second ranking RANK2, to be performed with a middle priority.

If the execution sequence of write commands among the commands CMD stored in the command queue A31 is scheduled by the command scheduler A32 at the first set time in this way, a write command operation for the first nonvolatile memory device A40 of the first/highest ranking RANK1 may be executed more frequently than a write command operation for the second nonvolatile memory device A50 of the second/middle ranking RANK2. Therefore, after the first set time, a probability that the temperature of the first nonvolatile memory device A40 of the first/highest ranking RANK1 rises may be greater than a probability that the temperature of the second nonvolatile memory device A50 of the second/middle ranking RANK2.

Similarly, if the execution sequence of write commands among the commands CMD stored in the command queue A31 is scheduled by the command scheduler A32 at the first set time, a write command operation for the second nonvolatile memory device A50 of the second/middle ranking RANK2 may be executed more frequently than a write command operation for the third nonvolatile memory device A60 of the third/lowest ranking RANK3 at the first set time. Therefore, after the first set time, a probability that the temperature of the second nonvolatile memory device A50 of the second/middle ranking RANK2 rises may be greater than a probability that the temperature of the third nonvolatile memory device A60 of the third/lowest ranking RANK3 rises.

Further, by way of example, at a second set time, which is later than the first set time, the first measurement value TRAN_TEMP1 transferred to the information collector A34 is 65, the second measurement value TRAN_TEMP2 is 40 and the third measurement value TRAN_TEMP3 is 45.

That is to say, when comparing the changes of the measurement values TRAN_TEMP1, TRAN_TEMP2 and TRAN_TEMP3 transferred to the information collector A34 at the first set time and the second set time, it may be seen that the first measurement value TRAN_TEMP1 has increased from 30 to 65 from the first to the second set time, the second measurement value TRAN_TEMP2 maintains its value of 40 at the second set time, which is the same as it was at the first set time, and the third measurement value TRAN_TEMP3 has decreased from 50 to 45 from the first to the second set time.

The reason why the measurement values TRAN_TEMP1, TRAN_TEMP2 and TRAN_TEMP3 transferred to the information collector A34 at the first set time and the second set time have changed in this way is because the execution sequence of the commands CMD stored in the command queue A31 has been adjusted depending on the rankings of the nonvolatile memory devices A40, A50 and A60 determined at the first set time.

In detail, the controller A30 requests, at the second set time, a value obtained by physically measuring the temperature of the first nonvolatile memory device A40, to the first temperature measurement circuit C10. Accordingly, the first temperature measurement circuit C10 transfers the value of 65, obtained by physically measuring the temperature of the first nonvolatile memory device A40, to the controller A30. The information collector A34 manages the value of 65 transferred from the first nonvolatile memory device A40, as the first measurement value TRAN_TEMP1.

The controller A30 requests, at the second set time, a value obtained by physically measuring the temperature of the second nonvolatile memory device A50, to the second temperature measurement circuit C20. Accordingly, the second temperature measurement circuit C20 transfers the value of 40, obtained by physically measuring the temperature of the second nonvolatile memory device A50, to the controller A30. The information collector A34 manages the value of 40 transferred from the second nonvolatile memory device A50, as the second measurement value TRAN_TEMP2.

The controller A30 requests, at the second set time, a value obtained by physically measuring the temperature of the third nonvolatile memory device A60, to the third temperature measurement circuit C30. Accordingly, the third temperature measurement circuit C30 transfers the value of 45, obtained by physically measuring the temperature of the third nonvolatile memory device A60, to the controller A30. The information collector A34 manages the value of 45 transferred from the third nonvolatile memory device A60, as the third measurement value TRAN_TEMP3.

Therefore, at the second set time, the information collector A34 included in the controller A30 manages the first measurement value TRAN_TEMP1 which has the value of 65, the second measurement value TRAN_TEMP2 which has the value of 40 and the third measurement value TRAN_TEMP3 which has the value of 45.

In this state, the ranking calculator A33 calculates that the average value AVER TEMP of the first to third measurement values TRAN_TEMP1, TRAN_TEMP2 and TRAN_TEMP3 transferred to the information collector A34. In this example, the average value AVER TEMP is calculated as 50, based on the first measurement value TRAN_TEMP1 having the value of 65, the second measurement value TRAN_TEMP2 having the value of 40 and the third measurement value TRAN_TEMP3 having the value of 45.

The ranking calculator A33 compares the calculated average value AVER TEMP of 50 with the respective first to third measurement values TRAN_TEMP1, TRAN_TEMP2 and TRAN_TEMP3, and calculates the rankings of the first to third nonvolatile memory devices A40, A50 and A60.

In detail, the ranking calculator A33 compares the first measurement value TRAN_TEMP1 of 65 with the calculated average value AVER TEMP of 50, and checks that the first measurement value TRAN_TEMP1 is greater by 15 than the average value AVER TEMP. The ranking calculator A33 compares the second measurement value TRAN_TEMP2 of 40 with the calculated average value AVER TEMP of 50, and checks that the second measurement value TRAN_TEMP2 is less by 10 than the average value AVER TEMP. The ranking calculator A33 compares the third measurement value TRAN_TEMP3 of 45 with the calculated average value AVER TEMP of 50, and checks that the third measurement value TRAN_TEMP3 is less by 5 than the average value AVER TEMP.

After comparing the calculated average value AVER TEMP of 50 with the respective first to third measurement values TRAN_TEMP1, TRAN_TEMP2 and TRAN_TEMP3 in this way, the ranking calculator A33 may determine the second nonvolatile memory device A50 corresponding to the second measurement value TRAN_TEMP2 which is less than the third measurement value TRAN_TEMP3 which is also less than the calculated average value AVER TEMP, as a first ranking RANK1. Also, the ranking calculator A33 may determine the third nonvolatile memory device A60 corresponding to the third measurement value TRAN_TEMP3 which is greater than the second measurement value TRAN_TEMP2, although less than the calculated average value AVER TEMP, as a second ranking RANK2. Furthermore, the ranking calculator A33 may determine the first nonvolatile memory device A40 corresponding to the first measurement value TRAN_TEMP1, which is greater than the calculated average value AVER TEMP, as a third ranking RANK3.

Summarizing the above description, at the second set time, the ranking calculator A33 may determine the first nonvolatile memory device A40 as the third ranking RANK3, determine the second nonvolatile memory device A50 as the first ranking RANK1 and determine the third nonvolatile memory device A60 as the second ranking RANK2, by using the first to third measurement values TRAN_TEMP1, TRAN_TEMP2 and TRAN_TEMP3 collected in the information collector A34.

After the rankings of the respective first to third nonvolatile memory devices A40, A50 and A60 are determined, the command scheduler A32 schedules the execution sequence of the commands CMD stored in the command queue A31 such that a command corresponding to a nonvolatile memory device of which ranking is relatively high among the first to third nonvolatile memory devices A40, A50 and A60 may be executed relatively earlier.

Thus, the command scheduler A32 schedules a command corresponding to the second nonvolatile memory device A50 which has a highest ranking by being determined as the first ranking RANK1 among the first to third nonvolatile memory devices A40, A50 and A60, to be performed with a highest priority. Also, the command scheduler A32 schedules a command corresponding to the first nonvolatile memory device A40 which has a lowest ranking by being determined as the third ranking RANK3, to be performed with a lowest priority. Furthermore, the command scheduler A32 schedules a command corresponding to the third nonvolatile memory device A60 which has a middle ranking by being determined as the second ranking RANK2, to be performed with a middle priority.

If the execution sequence of the commands CMD stored in the command queue A31 is scheduled by the command scheduler A32 at the second set time in this way, a command operation for the second nonvolatile memory device A50 of the first/highest ranking RANK1 may be executed more frequently than a command operation for the third nonvolatile memory device A60 of the second ranking/middle RANK2. Therefore, after the second set time, a probability that the temperature of the second nonvolatile memory device A50 of the first/highest ranking RANK1 rises may be greater than a probability that the temperature of the third nonvolatile memory device A60 of the second/middle ranking RANK2.

Similarly, if the execution sequence of the commands CMD stored in the command queue A31 is scheduled by the command scheduler A32 at the second set time, a command operation for the third nonvolatile memory device A60 of the second/middle ranking RANK2 may be executed more frequently than a command operation for the first nonvolatile memory device A40 of the third/lowest ranking RANK3 at the second set time. Therefore, after the second set time, a probability that the temperature of the third nonvolatile memory device A60 of the second/middle ranking RANK2 rises may be greater than a probability that the temperature of the first nonvolatile memory device A40 of the third/lowest ranking RANK3.

After the rankings of the respective first to third nonvolatile memory devices A40, A50 and A60 are determined, the command scheduler A32 schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier.

Thus, the command scheduler A32 schedules a write command corresponding to the second nonvolatile memory device A50 which has a highest ranking by being determined as the first ranking RANK1 among the first to third nonvolatile memory devices A40, A50 and A60, to be performed with a highest priority. Also, the command scheduler A32 schedules a write command corresponding to the first nonvolatile memory device A40 which has a lowest ranking by being determined as the third ranking RANKS, to be performed with a lowest priority. Furthermore, the command scheduler A32 schedules a write command corresponding to the third nonvolatile memory device A60 which has a middle ranking by being determined as the second ranking RANK2, to be performed with a middle priority.

If the execution sequence of write commands among the commands CMD stored in the command queue A31 is scheduled by the command scheduling unit A32 at the second set time in this way, a write command operation for the second nonvolatile memory device A50 of the first/highest ranking RANK1 may be executed more frequently than a write command operation for the third nonvolatile memory device A60 of the second/middle ranking RANK2. Therefore, after the second set time, a probability that the temperature of the second nonvolatile memory device A50 of the first/highest ranking RANK1 rises may be greater than a probability that the temperature of the third nonvolatile memory device A60 of the second/middle ranking RANK2.

Similarly, if the execution sequence of write commands among the commands CMD stored in the command queue A31 is scheduled by the command scheduler A32 at the second set time, a write command operation for the third nonvolatile memory device A60 of the second/middle ranking RANK2 may be executed more frequently than a write command operation for the first nonvolatile memory device A40 of the third/lowest ranking RANK3 at the second set time. Therefore, after the second set time, a probability that the temperature of the third nonvolatile memory device A60 of the second/middle ranking RANK2 rises may be greater than a probability that the temperature of the first nonvolatile memory device A40 of the third/lowest ranking RANK3.

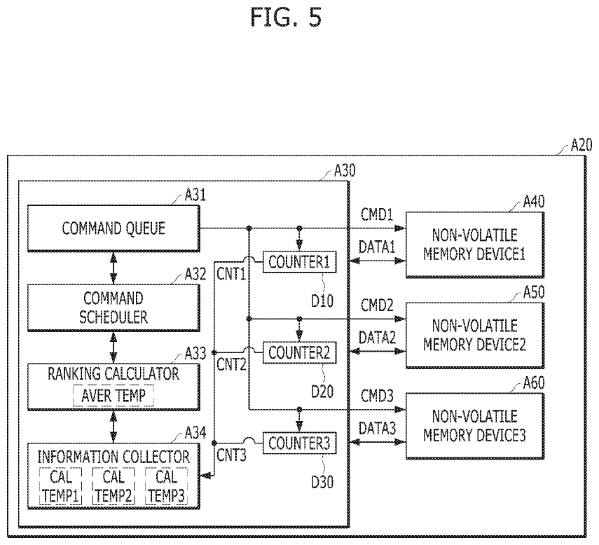

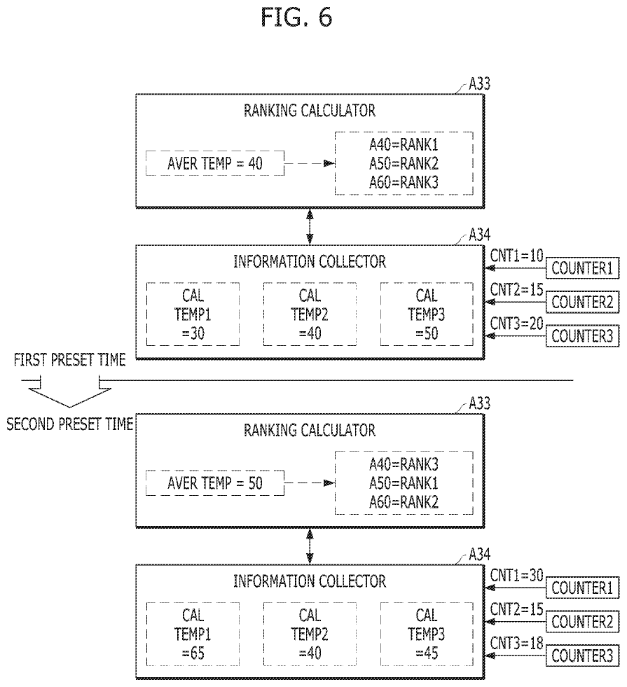

FIGS. 5 and 6 are diagrams illustrating an operation of the memory system A20 illustrated in FIGS. 1 and 2 in accordance with another embodiment of the present disclosure.

Referring to FIG. 5, the controller A30 includes the command queue A31, the command scheduler A32, the ranking calculator A33 and the information collector A34, and further includes a plurality of counters D10, D20 and D30 for counting the numbers of commands CMD1, CMD2 and CMD3 transferred to the nonvolatile memory devices A40, A50 and A60, respectively.

The first counter D10 counts the number of the first commands CMD1 which are transferred to the first nonvolatile memory device A40 from the controller A30, and generates a first counting value CNT1.

The second counter D20 counts the number of the second commands CMD2 which are transferred to the second nonvolatile memory device A50 from the controller A30, and generates a second counting value CNT2.

The third counter D30 counts the number of the third commands CMD3 which are transferred to the third nonvolatile memory device A60 from the controller A30, and generates a third counting value CNT3.

In this way, the counters D10, D20 and D30 count the numbers of the commands CMD1, CMD2 and CMD3 which are transferred to the nonvolatile memory devices A40, A50 and A60 from the controller A30, respectively, and generate the counting values CNT1, CNT2 and CNT3.

The controller A30 checks the respective counting values CNT1, CNT2 and CNT3 of the plurality of counters D10, D20 and D30 at each set time, calculates expectation values CAL_TEMP1, CAL_TEMP2 and CAL_TEMP3 as temperatures expected in the respective nonvolatile memory devices A40, A50 and A60, and then initializes the counters D10, D20 and D30.

In detail, the information collector A34 checks the first counting value CNT1 transferred from the first counter D10 at each set time, and calculates the first expectation value CAL_TEMP1 as a temperature expected in the first nonvolatile memory device A40.

The information collector A34 checks the second counting value CNT2 transferred from the second counter D20 at each set time, and calculates the second expectation value CAL_TEMP2 as a temperature expected in the second nonvolatile memory device A50.

The information collector A34 checks the third counting value CNT3 transferred from the third counter D30 at each set time, and calculates the third expectation value CAL_TEMP3 as a temperature expected in the third nonvolatile memory device A60.

In this way, the information collector A34 included in the controller A30 checks the counting values CNT1, CNT2 and CNT3 generated in the counters D10, D20 and D30, respectively, and calculates the expectation values CAL_TEMP1, CAL_TEMP2 and CAL_TEMP3 as temperatures expected in the nonvolatile memory devices A40, A50 and A60.

For reference, a scheme in which the information collector A34 calculates the expectation values CAL_TEMP1, CAL_TEMP2 and CAL_TEMP3 may be changed depending on the kind or operating method of the nonvolatile memory devices A40, A50 and A60. For example, the information collector A34 may expect that the temperatures of the nonvolatile memory devices A40, A50 and A60 are high as the counting values CNT1, CNT2 and CNT3 generated in the counters D10, D20 and D30 are relatively large, and thereby, may determine the expectation values CAL_TEMP1, CAL_TEMP2 and CAL_TEMP3. Conversely, the information collector A34 may expect that the temperatures of the nonvolatile memory devices A40, A50 and A60 are low as the counting values CNT1, CNT2 and CNT3 generated in the counters D10, D20 and D30 are relatively small, and thereby, may determine the expectation values CAL_TEMP1, CAL_TEMP2 and CAL_TEMP3.

The ranking calculator A33 included in the controller A30 calculates an average value AVER TEMP of the first to third expectation values CAL_TEMP1, CAL_TEMP2 and CAL_TEMP3 calculated by the information collector A34. That is, the ranking calculator A33 calculates an average temperature expected in the first to third nonvolatile memory devices A40, A50 and A60.

The ranking calculator A33 compares the calculated average value AVER TEMP with the first to third expectation values CAL_TEMP1, CAL_TEMP2 and CAL_TEMP3 calculated by the information collector A34. In other words, the ranking calculator A33 compares temperatures expected in the respective first to third nonvolatile memory devices A40, A50 and A60, with a temperature expected as an average in the entire first to third nonvolatile memory devices A40, A50 and A60.

Depending on a comparison result, the ranking calculator A33 determines the rankings of the respective first to third nonvolatile memory devices A40, A50 and A60.

For example, the ranking calculator A33 lowers the ranking of a nonvolatile memory device corresponding to an expectation value greater than the average value AVER TEMP to be less than the ranking of a nonvolatile memory device corresponding to an expectation value less than the average value AVER TEMP. In other words, the ranking calculator A33 lowers the ranking of a nonvolatile memory device expected to have a temperature greater than the average temperature to be less than the ranking of a nonvolatile memory device expected to have a temperature less than the average temperature.

The command scheduler A32 included in the controller A30 schedules the execution sequence of the commands CMD stored in the command queue A31, depending on the rankings calculated in the ranking calculator A33.

In this regard, the command scheduler A32 may schedule an execution sequence for all kinds of commands CMD stored in the command queue A31. Alternatively, the command scheduler A32 may schedule an execution sequence for only write commands among the commands CMD stored in the command queue A31.

Cases where the command scheduler A32 schedules an execution sequence for all kinds of commands CMD stored in the command queue A31 may be regarded as one embodiment.

A case where the command scheduler A32 schedules an execution sequence for only write commands among the commands CMD stored in the command queue A31 may be regarded as another embodiment.

The command scheduler A32 schedules the execution sequence of the commands CMD stored in the command queue A31 such that a command corresponding to a nonvolatile memory device of which ranking is relatively high among the first to third nonvolatile memory devices A40, A50 and A60 may be executed relatively earlier. Conversely, the command scheduler A32 schedules the execution sequence of the commands CMD stored in the command queue A31 such that a command corresponding to a nonvolatile memory device of which ranking is relatively low among the first to third nonvolatile memory devices A40, A50 and A60 may be executed relatively later.

In the embodiment directed to write commands, command scheduler A32 schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier.

Conversely, the command scheduler A32 schedules the execution sequence of write commands among the commands CMD stored in the command queue A31 such that a write command corresponding to a nonvolatile memory device of which ranking is relatively low among the first to third nonvolatile memory devices A40, A50 and A60 may be executed relatively later.

For reference, the reason why the operation of the command scheduler A32 is classified into different embodiments, as described above, is because temperatures may rise to the highest extent when the nonvolatile memory devices A40, A50 and A60 perform program operations in response to write commands.

Referring to FIG. 6, as an example, at a first set time, the first counting value CNT1 counted through the first counter D10 is 10, the second counting value CNT2 counted through the second counter D20 is 15 and the third counting value CNT3 counted through the third counter D30 is 20. Also, in the context of the present description, at the first set time, the first expectation value CAL_TEMP1, calculated by referring to the first counting value CNT1 of 10, is 30, the second expectation value CAL_TEMP2, calculated by referring to the second counting value CNT2 of 15, is 40, and the third expectation value CAL_TEMP3 calculated by referring to the third counting value CNT3 of 20, is 50.

In detail, at the first set time, the first counter D10 included in the controller A30 generates the value of 10 that is counted from a previous set time to the first set time, as the first counting value CNT1, transfers the first counting value CNT1 to the information collector A34, and is then initialized.

At the first set time, the second counter D20 included in the controller A30 generates the value of 15 that is counted from the previous set time to the first set time, as the second counting value CNT2, transfers the second counting value CNT2 to the information collector A34, and is then initialized.

At the first set time, the third counter D30 included in the controller A30 generates the value of 20 that is counted from the previous set time to the first set time, as the third counting value CNT3, transfers the third counting value CNT3 to the information collecting unit A34, and is then initialized.

At the first set time, the information collector A34 included in the controller A30 generates the first expectation value CAL_TEMP1 which is calculated as 30 as a temperature expected in the first nonvolatile memory device A40, by referring to the first counting value CNT1 of 10.

At the first set time, the information collector A34 included in the controller A30 generates the second expectation value CAL_TEMP2 which is calculated as 40 as a temperature expected in the second nonvolatile memory device A50, by referring to the second counting value CNT2 of 15.

At the first set time, the information collector A34 included in the controller A30 generates the third expectation value CAL_TEMP3 which is calculated as 50 as a temperature expected in the third nonvolatile memory device A60, by referring to the third counting value CNT3 of 20.

Therefore, at the first set time, the information collector A34 included in the controller A30 manages the first expectation value CAL_TEMP1 which has the value of 30 as a temperature expected in the first nonvolatile memory device A40, the second expectation value CAL_TEMP2 which has the value of 40 as a temperature expected in the second nonvolatile memory device A50, and the third expectation value CAL_TEMP3 which has the value of 50 as a temperature expected in the third nonvolatile memory device A60.

In this state, the ranking calculator A33 calculates that the average value AVER TEMP of the first to third expectation values CAL_TEMP1, CAL_TEMP2 and CAL_TEMP3 calculated by the information collector A34 is 40. That is, the average value AVER TEMP is calculated as 40 based on the first expectation value CAL_TEMP1 having the value of 30, the second expectation value CAL_TEMP2 having the value of 40 and the third expectation value CAL_TEMP3 having the value of 50.

The ranking calculator A33 compares the calculated average value AVER TEMP of 40 with the respective first to third expectation values CAL_TEMP1, CAL_TEMP2 and CAL_TEMP3, and calculates the rankings of the first to third nonvolatile memory devices A40, A50 and A60.

In detail, the ranking calculator A33 compares the first expectation value CAL_TEMP1 of 30 with the calculated average value AVER TEMP of 40, and checks that the first expectation value CAL_TEMP1 is less by 10 than the average value AVER TEMP. The ranking calculator A33 compares the second expectation value CAL_TEMP2 of 40 with the calculated average value AVER TEMP of 40, and checks that the second expectation value CAL_TEMP2 is equal to the average value AVER TEMP. The ranking calculator A33 compares the third expectation value CAL_TEMP3 of 50 with the calculated average value AVER TEMP of 40, and checks that the third expectation value CAL_TEMP3 is greater by 10 than the average value AVER TEMP.

After comparing the calculated average value AVER TEMP of 40 with the respective first to third expectation values CAL_TEMP1, CAL_TEMP2 and CAL_TEMP3 in this way, the ranking calculator A33 may determine the first nonvolatile memory device A40 corresponding to the first expectation value CAL_TEMP1, which is less than the calculated average value AVER TEMP, as a first ranking RANK1. Also, the ranking calculator A33 may determine the second nonvolatile memory device A50 corresponding to the second expectation value CAL_TEMP2, which is equal to the calculated average value AVER TEMP, as a second ranking RANK2. Furthermore, the ranking calculator A33 may determine the third nonvolatile memory device A60 corresponding to the third expectation value CAL_TEMP3, which is greater than the calculated average value AVER TEMP, as a third ranking RANKS.

Summarizing the above, at the first set time, the ranking calculator A33 may determine the first nonvolatile memory device A40 as the first ranking RANK1, determine the second nonvolatile memory device A50 as the second ranking RANK2 and determine the third nonvolatile memory device A60 as the third ranking RANK3, by using the first to third expectation values CAL_TEMP1, CAL_TEMP2 and CAL_TEMP3 calculated by the information collector A34.

After the rankings of the respective first to third nonvolatile memory devices A40, A50 and A60 are determined, the command scheduler A32 schedules the execution sequence of the commands CMD stored in the command queue A31 such that a command corresponding to a nonvolatile memory device of which ranking is relatively high among the first to third nonvolatile memory devices A40, A50 and A60 may be executed relatively earlier.

Thus, the command scheduler A32 schedules a command corresponding to the first nonvolatile memory device A40 which has a highest ranking by being determined as the first ranking RANK1, among the first to third nonvolatile memory devices A40, A50 and A60, to be performed with a highest priority. Also, the command scheduler A32 schedules a command corresponding to the third nonvolatile memory device A60, which has a lowest ranking by being determined as the third ranking RANK3, to be performed with a lowest priority. Furthermore, the command scheduler A32 schedules a command corresponding to the second nonvolatile memory device A50, which has a middle ranking by being determined as the second ranking RANK2, to be performed with a middle priority.

If the execution sequence of the commands CMD stored in the command queue A31 is scheduled by the command scheduler A32 at the first set time in this way, a command operation for the first nonvolatile memory device A40 of the first/highest ranking RANK′ may be executed more frequently than a command operation for the second nonvolatile memory device A50 of the second/middle ranking RANK2. Therefore, after the first set time, a probability that the temperature of the first nonvolatile memory device A40 of the first/highest ranking RANK1 rises may be greater than a probability that the temperature of the second nonvolatile memory device A50 of the second/middle ranking RANK2 rises.

Similarly, if the execution sequence of the commands CMD stored in the command queue A31 is scheduled by the command scheduler A32 at the first set time, a command operation for the second nonvolatile memory device A50 of the second/middle ranking RANK2 may be executed more frequently than a command operation for the third nonvolatile memory device A60 of the third/lowest ranking RANK3, at the first set time. Therefore, after the first set time, a probability that the temperature of the second nonvolatile memory device A50 of the second/middle ranking RANK2 rises may be greater than a probability that the temperature of the third nonvolatile memory device A60 of the third/lowest ranking RANK3.

After the rankings of the respective first to third nonvolatile memory devices A40, A50 and A60 are determined, the command scheduler A32 schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier.

Thus, the command scheduler A32 schedules a write command corresponding to the first nonvolatile memory device A40 which has a highest ranking by being determined as the first ranking RANK′ among the first to third nonvolatile memory devices A40, A50 and A60, to be performed with a highest priority. Also, the command scheduler A32 schedules a write command corresponding to the third nonvolatile memory device A60 which has a lowest ranking by being determined as the third ranking RANK3, to be performed with a lowest priority. Furthermore, the command scheduler A32 schedules a write command corresponding to the second nonvolatile memory device A50 which has a middle ranking by being determined as the second ranking RANK2, to be performed with a middle priority.

If the execution sequence of write commands among the commands CMD stored in the command queue A31 is scheduled by the command scheduler A32 at the first set time in this way, a write command operation for the first nonvolatile memory device A40 of the first ranking/highest RANK1 may be executed more frequently than a write command operation for the second nonvolatile memory device A50 of the second/middle ranking RANK2. Therefore, after the first set time, a probability that the temperature of the first nonvolatile memory device A40 of the first/highest ranking RANK1 rises may be greater than a probability that the temperature of the second nonvolatile memory device A50 of the second/middle ranking RANK2 rises.

Similarly, if the execution sequence of write commands among the commands CMD stored in the command queue A31 is scheduled by the command scheduler A32 at the first set time, a write command operation for the second nonvolatile memory device A50 of the second/middle ranking RANK2 may be executed more frequently than a write command operation for the third nonvolatile memory device A60 of the third/lowest ranking RANK3, at the first set time. Therefore, after the first set time, a probability that the temperature of the second nonvolatile memory device A50 of the second/middle ranking RANK2 rises may be greater than a probability that the temperature of the third nonvolatile memory device A60 of the third/lowest ranking RANK3 rises.

Further, by way of example, at a second set time later than the first set time, the first counting value CNT1 counted through the first counter D10 is 30, the second counting value CNT2 counted through the second counter D20 is 15 and the third counting value CNT3 counted through the third counter D30 is 18. Also, by way of example, at the second set time, the first expectation value CAL_TEMP1 calculated by the information collector A34 by referring to the first counting value CNT1 having the value of 30 is 65, the second expectation value CAL_TEMP2 calculated by referring to the second counting value CNT2 having the value of 15 is 40 and the third expectation value CAL_TEMP3 calculated by referring to the third counting value CNT3 having the value of 18 is 45.

That is to say, when comparing the changes of the expectation values CAL_TEMP1, CAL_TEMP2 and CAL_TEMP3 calculated by the information collector A34 at the first and second set times as described above, it may be seen that the first expectation value CAL_TEMP1 has increased to 65 at the second set time from 30 at the first set time, the second expectation value CAL_TEMP2 maintains its value of 40 at the second set time, which is the same as it was at the first set time, and the third expectation value CAL_TEMP3 has decreased to 45 at the second set time from 50 at the first set time.

The reason why the expectation values CAL_TEMP1, CAL_TEMP2 and CAL_TEMP3 calculated by the information collector A34 at the first set time and the second set time have changed in this way is because the execution sequence of the commands CMD stored in the command queue A31 has been adjusted depending on the rankings of the nonvolatile memory devices A40, A50 and A60 determined at the first set time.

In detail, at the second set time, the first counter D10 included in the controller A30 generates the value of 30 that is counted from the first set time to the second set time, as the first counting value CNT1, transfers the first counting value CNT1 to the information collector A34, and is then initialized.

At the second set time, the second counter D20 included in the controller A30 generates the value of 15 that is counted from the first set time to the second set time, as the second counting value CNT2, transfers the second counting value CNT2 to the information collector A34, and is then initialized.

At the second set time, the third counter D30 included in the controller A30 generates the value of 18 that is counted from the first set time to the second set time, as the third counting value CNT3, transfers the third counting value CNT3 to the information collector A34, and is then initialized.

At the second set time, the information collector A34 included in the controller A30 generates the first expectation value CAL_TEMP1 which is calculated as 65, as a temperature expected in the first nonvolatile memory device A40, by referring to the first counting value CNT1 of 30 transferred from the first counter D10.

At the second set time, the information collector A34 included in the controller A30 generates the second expectation value CAL_TEMP2 which is calculated as 40, as a temperature expected in the second nonvolatile memory device A50, by referring to the second counting value CNT2 of 15 transferred from the second counter D20.

At the second set time, the information collector A34 included in the controller A30 generates the third expectation value CAL_TEMP3 which is calculated as 45, as a temperature expected in the third nonvolatile memory device A60, by referring to the third counting value CNT3 of 18 transferred from the third counter D30.

Therefore, at the second set time, the information collector A34 included in the controller A30 manages the first expectation value CAL_TEMP1 which has the value of 65 as a temperature expected in the first nonvolatile memory device A40, the second expectation value CAL_TEMP2 which has the value of 40 as a temperature expected in the second nonvolatile memory device A50 and the third expectation value CAL_TEMP3 which has the value of 45 as a temperature expected in the third nonvolatile memory device A60.

In this state, the ranking calculator A33 calculates that the average value AVER TEMP of the first to third expectation values CAL_TEMP1, CAL_TEMP2 and CAL_TEMP3 calculated by the information collector A34 is 50. That is, the average value AVER TEMP of 50 is calculated based on the first expectation value CAL_TEMP1 having the value of 65, the second expectation value CAL_TEMP2 having the value of 40 and the third expectation value CAL_TEMP3 having the value of 45.

The ranking calculator A33 compares the calculated average value AVER TEMP of 50 with the respective first to third expectation values CAL_TEMP1, CAL_TEMP2 and CAL_TEMP3, and calculates the rankings of the first to third nonvolatile memory devices A40, A50 and A60.

In detail, the ranking calculator A33 compares the first expectation value CAL_TEMP1 of 65 with the calculated average value AVER TEMP of 50, and checks that the first expectation value CAL_TEMP1 is greater by 15 than the average value AVER TEMP. The ranking calculator A33 compares the second expectation value CAL_TEMP2 of 40 with the calculated average value AVER TEMP of 50, and checks that the second expectation value CAL_TEMP2 is less by 10 than the average value AVER TEMP. The ranking calculator A33 compares the third expectation value CAL_TEMP3 of 45 with the calculated average value AVER TEMP of 50, and checks that the third expectation value CAL_TEMP3 is less by 5 than the average value AVER TEMP.

After comparing the calculated average value AVER TEMP of 50 with the respective first to third expectation values CAL_TEMP1, CAL_TEMP2 and CAL_TEMP3 in this way, the ranking calculator A33 may determine the second nonvolatile memory device A50 corresponding to the second expectation value CAL_TEMP2, which is lower than the third expectation value CAL_TEMP3, both of which are lower than the calculated average value AVER TEMP, as a first ranking RANK1. Also, the ranking calculator A33 may determine the third nonvolatile memory device A60 corresponding to the third expectation value CAL_TEMP3 which is higher between the second expectation value CAL_TEMP2, as a second ranking RANK2. Furthermore, the ranking calculator A33 may determine the first nonvolatile memory device A40 corresponding to the first expectation value CAL_TEMP1 that is greater than the calculated average value AVER TEMP, as a third ranking RANK3.

Summarizing the above, at the second set time, the ranking calculator A33 may determine the first nonvolatile memory device A40 as the third ranking RANK3, determine the second nonvolatile memory device A50 as the first ranking RANK1 and determine the third nonvolatile memory device A60 as the second ranking RANK2, by using the first to third expectation values CAL_TEMP1, CAL_TEMP2 and CAL_TEMP3 calculated by the information collector A34.

After the rankings of the respective first to third nonvolatile memory devices A40, A50 and A60 are determined, the command scheduler A32 schedules the execution sequence of the commands CMD stored in the command queue A31 such that a command corresponding to a nonvolatile memory device of which ranking is relatively high among the first to third nonvolatile memory devices A40, A50 and A60 may be executed relatively earlier.

Thus, the command scheduler A32 schedules a command corresponding to the second nonvolatile memory device A50 which has a highest ranking by being determined as the first ranking RANK1 among the first to third nonvolatile memory devices A40, A50 and A60, to be performed with a highest priority. Also, the command scheduler A32 schedules a command corresponding to the first nonvolatile memory device A40 which has a lowest ranking by being determined as the third ranking RANK3, to be performed with a lowest priority. Furthermore, the command scheduler A32 schedules a command corresponding to the third nonvolatile memory device A60 which has a middle ranking by being determined as the second ranking RANK2, to be performed with a middle priority.

If the execution sequence of the commands CMD stored in the command queue A31 is scheduled by the command scheduler A32 at the second set time in this way, a command operation for the second nonvolatile memory device A50 of the first/highest ranking RANK1 may be executed more frequently than a command operation for the third nonvolatile memory device A60 of the second/middle ranking RANK2. Therefore, after the second set time, a probability that the temperature of the second nonvolatile memory device A50 of the first/highest ranking RANK1 rises may be greater than a probability that the temperature of the third nonvolatile memory device A60 of the second/middle ranking RANK2 rises.

Similarly, if the execution sequence of the commands CMD stored in the command queue A31 is scheduled by the command scheduler A32 at the second set time, a command operation for the third nonvolatile memory device A60 of the second/middle ranking RANK2 may be executed more frequently than a command operation for the first nonvolatile memory device A40 of the third/lowest ranking RANK3, at the second set time. Therefore, after the second set time, a probability that the temperature of the third nonvolatile memory device A60 of the second/middle ranking RANK2 rises may be greater than a probability that the temperature of the first nonvolatile memory device A40 of the third/lowest ranking RANK3 rises.

After the rankings of the respective first to third nonvolatile memory devices A40, A50 and A60 are determined, the command scheduler A32 schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier.

Thus, the command scheduler A32 schedules a write command corresponding to the second nonvolatile memory device A50 which has a highest ranking by being determined as the first ranking RANK1 among the first to third nonvolatile memory devices A40, A50 and A60, to be performed with a highest priority. Also, the command scheduler A32 schedules a write command corresponding to the first nonvolatile memory device A40 which has a lowest ranking by being determined as the third ranking RANK3, to be performed with a lowest priority. Furthermore, the command scheduler A32 schedules a write command corresponding to the third nonvolatile memory device A60 which has a middle ranking by being determined as the second ranking RANK2, to be performed with a middle priority.

If the execution sequence of write commands among the commands CMD stored in the command queue A31 is scheduled by the command scheduler A32 at the second set time in this way, a write command operation for the second nonvolatile memory device A50 of the first/highest ranking RANK1 may be executed more frequently than a write command operation for the third nonvolatile memory device A60 of the second/middle ranking RANK2. Therefore, after the second set time, a probability that the temperature of the second nonvolatile memory device A50 of the first/highest ranking RANK1 rises may be greater than a probability that the temperature of the third nonvolatile memory device A60 of the second/middle ranking RANK2 rises.

Similarly, if the execution sequence of write commands among the commands CMD stored in the command queue A31 is scheduled by the command scheduler A32 at the second set time, a write command operation for the third nonvolatile memory device A60 of the second/middle ranking RANK2 may be executed more frequently than a write command operation for the first nonvolatile memory device A40 of the third/lowest ranking RANK3 at the second set time. Therefore, after the second set time, a probability that the temperature of the third nonvolatile memory device A60 of the second/middle ranking RANK2 rises may be greater than a probability that the temperature of the first nonvolatile memory device A40 of the third/lowest ranking RANK3 rises.

FIGS. 7, 8A and 8B are diagrams illustrating an operation of the memory system A20 illustrated in FIGS. 1 and 2 in accordance with still another embodiment of the present disclosure.

Referring to FIG. 7, the controller A30 includes the command queue A31, the command scheduler A32, the ranking calculator A33 and the information collector A34.

In this embodiment, the measurement values TRAN_TEMP1, TRAN_TEMP2 and TRAN_TEMP3 described above with reference to FIG. 3 or the expectation values CAL_TEMP1, CAL_TEMP2 and CAL_TEMP3 described above with reference to FIG. 5 are managed in the information collector A34.

Namely, in FIG. 7, temperatures for the respective nonvolatile memory devices A40, A50 and A60 are included already in the information collector A34 as the measurement values TRAN_TEMP1, TRAN_TEMP2 and TRAN_TEMP3 according to the scheme described above with reference to FIG. 3 or the expectation values CAL_TEMP1, CAL_TEMP2 and CAL_TEMP3 according to the scheme described above with reference to FIG. 5.

Thus, in FIG. 7, the reference symbols TEMP1, TEMP2 and TEMP3 included in the information collector A34 may be the measurement values TRAN_TEMP1, TRAN_TEMP2 and TRAN_TEMP3 according to the scheme described above with reference to FIG. 3 or the expectation values CAL_TEMP1, CAL_TEMP2 and CAL_TEMP3 according to the scheme described above with reference to FIG. 5.

In detail, in the case of two or more memory devices of which temperatures are within a set temperature range among the nonvolatile memory devices A40, A50 and A60, when determining rankings for the two or more memory devices, the controller A30 checks parameter information PARA1, PARA2 and PARA3 for the respective two or more memory devices.

That is to say, in the case where the temperature values TEMP1, TEMP2 and TEMP3 for the respective two or more memory devices among the nonvolatile memory devices A40, A50 and A60 do not have a difference greater than a set value, when determining rankings for the respective two or more memory devices, the parameter information PARA1, PARA2 and PARA3 for the respective two or more memory devices are checked.

For example, as a result of checking the parameter information PARA1, PARA2 and PARA3 of the respective two or more memory devices which have temperatures within the set temperature range among the nonvolatile memory devices A40, A50 and A60, the controller A30 may determine the ranking of a memory device in which the number of free blocks is relatively large, among the two or more memory devices, to be relatively higher.

As a result of checking the parameter information PARA1, PARA2 and PARA3 of the respective two or more memory devices which have temperatures included within the set temperature range among the nonvolatile memory devices A40, A50 and A60, the controller A30 may determine the ranking of a memory device in which the number of bad blocks is relatively small, among the two or more memory devices, to be relatively higher.

As a result of checking the parameter information PARA1, PARA2 and PARA3 of the respective two or more memory devices which have temperatures included within the set temperature range among the nonvolatile memory devices A40, A50 and A60, the controller A30 may determine the ranking of a memory device in which the value of a read reclaim count accumulated based on a set time is relatively small, among the two or more memory devices, to be relatively higher.

As a result of checking the parameter information PARA1, PARA2 and PARA3 of the respective two or more memory devices which have temperatures included within the set temperature range among the nonvolatile memory devices A40, A50 and A60, the controller A30 may determine the ranking of a memory device in which the size of write data accumulated based on a set time is relatively small, among the two or more memory devices, to be relatively higher.

As a result of checking the parameter information PARA1, PARA2 and PARA3 of the respective two or more memory devices which have temperatures included within the set temperature range among the nonvolatile memory devices A40, A50 and A60, the controller A30 may determine the ranking of a memory device in which the length of an idle time based on a set time is relatively long among the two or more memory devices, to be relatively higher.

Referring to FIG. 8A, as an example, the measurement values TRAN_TEMP1, TRAN_TEMP2 and TRAN_TEMP3, all of which have the same value, are managed in the information collector A34 in the controller A30.

In detail, as an example, the first measurement value TRAN_TEMP1 managed in the information collector A34 is 40, the second measurement value TRAN_TEMP2 is 40 and the third measurement value TRAN_TEMP3 is 40. In other words, in this example, all the measurement values TRAN_TEMP1, TRAN_TEMP2 and TRAN_TEMP3 have the same value, i.e., 40, and accordingly the average value AVER TEMP calculated in the ranking calculator A33 is 40 as well.

In the case where, in this way, the measurement values TRAN_TEMP1, TRAN_TEMP2 and TRAN_TEMP3 managed in the information collector A34 do not have a difference greater than a set value, rankings for the nonvolatile memory devices A40, A50 and A60 cannot be determined with only the measurement values TRAN_TEMP1, TRAN_TEMP2 and TRAN_TEMP3.

Thus, the controller A30 receives the parameter information PARA1, PARA2 and PARA3 of memory devices of which rankings cannot be determined through the measurement values TRAN_TEMP1, TRAN_TEMP2 and TRAN_TEMP3 among the nonvolatile memory devices A40, A50 and A60, and manages them in the information collector A34.

In the embodiment of FIG. 8A, the ranking for each memory device of the group, e.g., A40, A50 and A60 cannot be determined through the measurement values TRAN_TEMP1, TRAN_TEMP2 and TRAN_TEMP3 alone. However, this is a mere example. In practice, there is a case in which the rankings of some memory devices can be determined through measurement values, in which case parameter information may or may not be managed.

In this way, as a result of receiving and checking the parameter information PARA1, PARA2 and PARA3 of the respective nonvolatile memory devices A40, A50 and A60 by the information collector A34 included in the controller A30, the parameter information PARA1 of the first nonvolatile memory device A40 has the value of L, the parameter information PARA2 of the second nonvolatile memory device A50 has the value of H as a grade greater than L and the parameter information PARA3 of the third nonvolatile memory device A60 has the value of M as a grade greater than L and less than H.

In the present context, as compared to the grade corresponding to the value of M, the grade corresponding to the value of H among the parameter information PARA1, PARA2 and PARA3 is relatively larger in the number of free blocks, is relatively smaller in the number of bad blocks, is relatively smaller in the value of a read reclaim count accumulated based on a set time, is relatively smaller in the size of write data accumulated based on a set time or is relatively longer in the length of an idle time based on a set time.

Similarly, in the present context, as compared to the grade corresponding to the value of L, the grade corresponding to the value of M among the parameter information PARA1, PARA2 and PARA3 is relatively larger in the number of free blocks, is relatively smaller in the number of bad blocks, is relatively smaller in the value of a read reclaim count accumulated based on a set time, is relatively smaller in the size of write data accumulated based on a set time or is relatively longer in the length of an idle time based on a set time.

In correspondence to that, as described above, the parameter information PARA1 of the first nonvolatile memory device A40 in the information collector A34 has the value of L, the parameter information PARA2 of the second nonvolatile memory device A50 has the value of H as a grade greater than L and the parameter information PARA3 of the third nonvolatile memory device A60 has the value of M as a grade greater than L and less than H, the ranking calculator A33 may determine the first nonvolatile memory device A40 as a third ranking RANKS, may determine the second nonvolatile memory device A50 as a first ranking RANK1 and may determine the third nonvolatile memory device A60 as a second ranking RANK2.

After the ranking calculator A33 determines rankings for the first to third nonvolatile memory devices A40, A50 and A60 by using the parameter information PARA1, PARA2 and PARA3 in this way, the command scheduler A32 schedules a command corresponding to the second nonvolatile memory device A50 which has a highest ranking by being determined as the first ranking RANK1 among the first to third nonvolatile memory devices A40, A50 and A60, to be performed with a highest priority. Also, the command scheduler A32 schedules a command corresponding to the first nonvolatile memory device A40 which has a lowest ranking by being determined as the third ranking RANK3, to be performed with a lowest priority. Furthermore, the command scheduler A32 schedules a command corresponding to the third nonvolatile memory device A60 which has a middle ranking by being determined as the second ranking RANK2, to be performed with a middle priority.

If the execution sequence of the commands CMD stored in the command queue A31 is scheduled by the command scheduler A32 in this way, a command operation for the second nonvolatile memory device A50 of the first/highest ranking RANK1 may be executed more frequently than a command operation for the third nonvolatile memory device A60 of the second/middle ranking RANK2. Therefore, after the operation of the command scheduler A32, a probability that the temperature of the second nonvolatile memory device A50 of the first/highest ranking RANK1 rises may be greater than a probability that the temperature of the third nonvolatile memory device A60 of the second/middle ranking RANK2 rises.

Similarly, if the execution sequence of the commands CMD stored in the command queue A31 is scheduled by the command scheduler A32, a command operation for the third nonvolatile memory device A60 of the second/middle ranking RANK2 may be executed more frequently than a command operation for the first nonvolatile memory device A40 of the third/lowest ranking RANK3. Therefore, after the operation of the command scheduler A32, a probability that the temperature of the third nonvolatile memory device A60 of the second/middle ranking RANK2 rises may be greater than a probability that the temperature of the first nonvolatile memory device A40 of the third/lowest ranking RANK3 rises.

After rankings for the first to third nonvolatile memory devices A40, A50 and A60 are determined by using the parameter information PARA1, PARA2 and PARA3 in the ranking calculator A33, the command scheduler A32 schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier.

Thus, the command scheduler A32 schedules a write command corresponding to the second nonvolatile memory device A50 which has a highest ranking by being determined as the first ranking RANK1 among the first to third nonvolatile memory devices A40, A50 and A60, to be performed with a highest priority. Also, the command scheduler A32 schedules a write command corresponding to the first nonvolatile memory device A40 which has a lowest ranking by being determined as the third ranking RANKS, to be performed with a lowest priority. Furthermore, the command scheduler A32 schedules a write command corresponding to the third nonvolatile memory device A60 which has a middle ranking by being determined as the second ranking RANK2, to be performed with a middle priority.

If the execution sequence of write commands among the commands CMD stored in the command queue A31 is scheduled by the command scheduler A32 in this way, a write command operation for the second nonvolatile memory device A50 of the first/highest ranking RANK1 may be executed more frequently than a write command operation for the third nonvolatile memory device A60 of the second/middle ranking RANK2. Therefore, after the operation of the command scheduling unit A32, a probability that the temperature of the second nonvolatile memory device A50 of the first/highest ranking RANK1 rises may be greater than a probability that the temperature of the third nonvolatile memory device A60 of the second/middle ranking RANK2 rises.

Similarly, if the execution sequence of write commands among the commands CMD stored in the command queue A31 is scheduled by the command scheduler A32, a write command operation for the third nonvolatile memory device A60 of the second/middle ranking RANK2 may be executed more frequently than a write command operation for the first nonvolatile memory device A40 of the third/lowest ranking RANK3. Therefore, after the operation of the command scheduler A32, a probability that the temperature of the third nonvolatile memory device A60 of the second/middle ranking RANK2 rises may be greater than a probability that the temperature of the first nonvolatile memory device A40 of the third/lowest ranking RANK3 rises.

Referring to FIG. 8B, the expectation values CAL_TEMP1, CAL_TEMP2 and CAL_TEMP3, all of which have the same value, are managed by the information collector A34 included in the controller A30.

In detail, by way of example, the first counting value CNT1 generated in the first counter D10 is 10, the second counting value CNT2 generated in the second counter D20 is 10 and the third counting value CNT3 generated in the third counter D30 is 10. Also, by way of example, the first expectation value CAL_TEMP1 calculated in correspondence to the first counting value CNT1 having the value of 10 is 30, the second expectation value CAL_TEMP2 calculated in correspondence to the second counting value CNT2 having the value of 10 is 30 and the third expectation value CAL_TEMP3 calculated in correspondence to the third counting value CNT3 having the value of 10 is 30.

In the case where, in this way, the expectation values CAL_TEMP1, CAL_TEMP2 and CAL_TEMP3 managed by the information collector A34 do not have a difference greater than a set value, rankings for the nonvolatile memory devices A40, A50 and A60 cannot be determined with only the expectation values CAL_TEMP1, CAL_TEMP2 and CAL_TEMP3.

Thus, the controller A30 receives the parameter information PARA1, PARA2 and PARA3 of memory devices of which rankings cannot be determined through the expectation values CAL_TEMP1, CAL_TEMP2 and CAL_TEMP3 among the nonvolatile memory devices A40, A50 and A60, and manages them in the information collector A34.

For reference, in FIG. 8B, as an example, all of the nonvolatile memory devices A40, A50 and A60 are exemplified as memory devices of which rankings cannot be determined through the expectation values CAL_TEMP1, CAL_TEMP2 and CAL_TEMP3. However, this is a mere example. In practice, in the case of some memory devices of which rankings can be determined through measurement values, parameter information may or may not be managed.

In this way, as a result of, receiving and checking the parameter information PARA1, PARA2 and PARA3 of the respective nonvolatile memory devices A40, A50 and A60 by the information collector A34 in the controller A30, the parameter information PARA1 of the first nonvolatile memory device A40 has the value of H, the parameter information PARA2 of the second nonvolatile memory device A50 has the value of L as a grade less than H and the parameter information PARA3 of the third nonvolatile memory device A60 has the value of M as a grade greater than L and less than H.

In the present context, as compared to the grade corresponding to the value of M, the grade corresponding to the value of H among the parameter information PARA1, PARA2 and PARA3 is relatively larger in the number of free blocks, is relatively smaller in the number of bad blocks, is relatively smaller in the value of a read reclaim count accumulated based on a set time, is relatively smaller in the size of write data accumulated based on a set time or is relatively longer in the length of an idle time based on a set time.

Similarly, in the present context, as compared to the grade corresponding to the value of L, the grade corresponding to the value of M among the parameter information PARA1, PARA2 and PARA3 is relatively larger in the number of free blocks, is relatively smaller in the number of bad blocks, is relatively smaller in the value of a read reclaim count accumulated based on a set time, is relatively smaller in the size of write data accumulated based on a set time or is relatively longer in the length of an idle time based on a set time.

In correspondence to that, as described above, the parameter information PARA1 of the first nonvolatile memory device A40 in the information collector A34 has the value of H, the parameter information PARA2 of the second nonvolatile memory device A50 has the value of L as a grade less than H and the parameter information PARA3 of the third nonvolatile memory device A60 has the value of M as a grade greater than L and less than H, the ranking calculator A33 may determine the first nonvolatile memory device A40 as a first ranking RANK1, may determine the second nonvolatile memory device A50 as a third ranking RANK3 and may determine the third nonvolatile memory device A60 as a second ranking RANK2.

After the ranking calculator A33 determines rankings for the first to third nonvolatile memory devices A40, A50 and A60 by using the parameter information PARA1, PARA2 and PARA3 in this way, the command scheduler A32 schedules a command corresponding to the first nonvolatile memory device A40 which has a highest ranking by being determined as the first ranking RANK1 among the first to third nonvolatile memory devices A40, A50 and A60, to be performed with a highest priority. Also, the command scheduler A32 schedules a command corresponding to the second nonvolatile memory device A50 which has a lowest ranking by being determined as the third ranking RANK3, to be performed with a lowest priority. Furthermore, the command scheduler A32 schedules a command corresponding to the third nonvolatile memory device A60 which has a middle ranking by being determined as the second ranking RANK2, to be performed with a middle priority.

If the execution sequence of the commands CMD stored in the command queue A31 is scheduled by the command scheduler A32 in this way, a command operation for the first nonvolatile memory device A40 of the first/highest ranking RANK1 may be executed more frequently than a command operation for the third nonvolatile memory device A60 of the second/middle ranking RANK2. Therefore, after the operation of the command scheduler A32, a probability that the temperature of the first nonvolatile memory device A40 of the first/highest ranking RANK1 rises may be greater than a probability that the temperature of the third nonvolatile memory device A60 of the second/middle ranking RANK2 rises.

Similarly, if the execution sequence of the commands CMD stored in the command queue A31 is scheduled by the command scheduler A32, a command operation for the third nonvolatile memory device A60 of the second/middle ranking RANK2 may be executed more frequently than a command operation for the second nonvolatile memory device A50 of the third/lowest ranking RANK3. Therefore, after the operation of the command scheduler A32, a probability that the temperature of the third nonvolatile memory device A60 of the second/middle ranking RANK2 rises may be greater than a probability that the temperature of the second nonvolatile memory device A50 of the third/lowest ranking RANK3 rises.

After rankings for the first to third nonvolatile memory devices A40, A50 and A60 are determined by using the parameter information PARA1, PARA2 and PARA3 in the ranking calculator A33, the command scheduler A32 schedules the execution sequence of write commands among the commands CMD stored in the command queue A31 such that a write command corresponding to a nonvolatile memory device of which ranking is relatively high among the first to third nonvolatile memory devices A40, A50 and A60 may be executed relatively earlier.

Thus, the command scheduler A32 schedules a write command corresponding to the first nonvolatile memory device A40 which has a highest ranking by being determined as the first ranking RANK′ among the first to third nonvolatile memory devices A40, A50 and A60, to be performed with a highest priority. Also, the command scheduler A32 schedules a write command corresponding to the second nonvolatile memory device A50 which has a lowest ranking by being determined as the third ranking RANK3, to be performed with a lowest priority. Furthermore, the command scheduler A32 schedules a write command corresponding to the third nonvolatile memory device A60 which has a middle ranking by being determined as the second ranking RANK2, to be performed with a middle priority.

If the execution sequence of write commands among the commands CMD stored in the command queue A31 is scheduled by the command scheduler A32 in this way, a write command operation for the first nonvolatile memory device A40 of the first/highest ranking RANK1 may be executed more frequently than a write command operation for the third nonvolatile memory device A60 of the second/middle ranking RANK2. Therefore, after the operation of the command scheduler A32, a probability that the temperature of the first nonvolatile memory device A40 of the first/highest ranking RANK1 rises may be greater than a probability that the temperature of the third nonvolatile memory device A60 of the second/middle ranking RANK2 rises.

Similarly, if the execution sequence of write commands among the commands CMD stored in the command queue A31 is scheduled by the command scheduler A32, a write command operation for the third nonvolatile memory device A60 of the second/middle ranking RANK2 may be executed more frequently than a write command operation for the second nonvolatile memory device A50 of the third/lowest ranking RANK3. Therefore, after the operation of the command scheduler A32, a probability that the temperature of the third nonvolatile memory device A60 of the second/middle ranking RANK2 rises may be greater than a probability that the temperature of the second nonvolatile memory device A50 of the third/lowest ranking RANK3 rises.

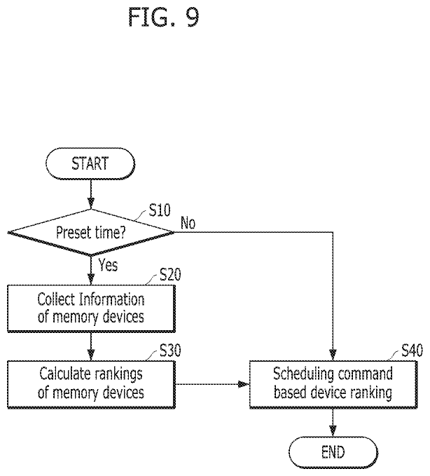

FIG. 9 is a flow chart illustrating an operation of the memory system A20 illustrated in FIGS. 1 and 2 in accordance with an embodiment of the present disclosure.

Referring to FIG. 9, the controller A30 checks whether a set time has been reached (S10).

In various embodiments, the set time may be a first time that is requested to the controller A30 of the memory system A20 from the host A10.

In various embodiments, the set time may be a second time that is repeated with a set time interval in the controller A30.

In various embodiments, the set time may be a third time that is repeated each time the size of data inputted/outputted between the controller A30 of the memory system A20 and the host A10 becomes a set size. In other words, the controller A30 may check how large the size of data inputted/outputted between the controller A30 and the host A10 is, and may determine a time when the checked size becomes the set size, as the third time.

In various embodiments, the set time may be a fourth time that is repeated each time the number of commands CMD transferred from the host MO to the controller A30 of the memory system A20 reaches a set number. In other words, the controller A30 may count the number of the commands CMD received from the host MO, and may determine a time when the counted number becomes the set number, as the fourth time.

In various embodiments, the set time may be a fifth time at which it is checked that an idle time is maintained in the controller A30 itself of the memory system A20 for at least a set time. In other words, the controller A30 may check how long the maintenance time of an idle period in which any operation request is not generated from the host A10 is. Further, the controller A30 may determine a time at which the checked time exceeds the predetermined time, as the fifth time.

As described above, the set time may be at least one time among the first time, the second time, the third time, the fourth time and the fifth time. The first time is the time that is requested to the controller A30 of the memory system A20 from the host A10. The second time is the time that is repeated with a set time interval in the controller A30 of the memory system A20. The third time is the time that is repeated each time the size of data inputted/outputted between the controller A30 of the memory system A20 and the host MO becomes a set size. The fourth time is the time that is repeated each time the number of commands CMD received from the host MO to the controller A30 of the memory system A20 reaches a set number. The fifth time is the time at which it is checked that an idle time is maintained in the controller A30 itself of the memory system A20 for at least a set time.

In the case where the set time has been reached as a result of the step S10 (YES), the controller A30 collects the information of the respective nonvolatile memory devices A40, A50 and A60 (S20). The information of the respective nonvolatile memory devices A40, A50 and A60 may be the temperature information of the respective nonvolatile memory devices A40, A50 and A60. Moreover, the information of the respective nonvolatile memory devices A40, A50 and A60 may be the parameter information of the respective nonvolatile memory devices A40, A50 and A60.

The controller A30 calculates the rankings of the respective nonvolatile memory devices A40, A50 and A60 by using the information of the respective nonvolatile memory devices A40, A50 and A60 which are collected at the step S20 (S30).

Since a detailed method of the step S20 of collecting the information of the respective nonvolatile memory devices A40, A50 and A60 and a detailed method of the step S30 of determining the rankings of the respective nonvolatile memory devices A40, A50 and A60 were described above with reference to FIGS. 3 to 8B, description thereof is omitted here.

If the rankings of the respective nonvolatile memory devices A40, A50 and A60 are determined through the step S20 and the step S30 described above, the controller A30 schedules commands CMD1, CMD2 and CMD3 to be transferred to the respective nonvolatile memory devices A40, A50 and A60, based on the rankings newly determined for the nonvolatile memory devices A40, A50 and A60 (S40).

In the case where the set time has not been reached as a result of the step S10 (NO), the controller A30 schedules commands CMD1, CMD2 and CMD3 to be transferred to the respective nonvolatile memory devices A40, A50 and A60, based on rankings previously determined for the nonvolatile memory devices A40, A50 and A60 (S40).

Namely, in the case where the set time has not been reached as a result of the step S10 (NO), the controller A30 does not newly define rankings for the nonvolatile memory devices A40, A50 and A60 through the step S20 and the step S30 described above.

Although various embodiments have been illustrated and described, it will be apparent to those skilled in the art in light of the present disclosure that various changes and modifications may be made without departing from the spirit and scope of the invention as defined in the following claims.

What is claimed is:

1. A memory system comprising:
a plurality of nonvolatile memory devices;
a command queue suitable for storing a set number of commands received from a host; and
a controller suitable for generating temperature information by checking temperatures of the respective nonvolatile memory devices at each set time, calculating rankings of the respective nonvolatile memory devices by using the temperature information, and scheduling an execution sequence of the commands stored in the command queue, based on the calculated rankings.

2. The memory system according to claim 1, wherein the set time is any among
a first time requested from the host,
a second time repeated with a set time interval,
a third time repeated each time a size of data transmitted by the controller to, or received by the controller from, the host is a set size,
a fourth time repeated each time commands received by the controller from the host is a set number, and
a fifth time at which an idle time of the controller is maintained for at least a set time.

3. The memory system according to claim 2, wherein
each of the nonvolatile memory devices includes a plurality of memory blocks,
the controller calculates rankings of the respective nonvolatile memory devices by using the temperature information and parameter information for the respective nonvolatile memory devices, and
the parameter information includes at least one of information on the number of free blocks among the memory blocks in each of the nonvolatile memory devices, information on the number of bad blocks among the memory blocks, information on a read reclaim count accumulated based on the set time, information on a size of write data accumulated based on the set time, and information on a length of an idle time based on the set time.

4. The memory system according to claim 3, wherein
the respective nonvolatile memory devices include temperature measurement circuits for physically measuring temperatures thereof, and
the controller receives information on temperatures measured by the temperature measurement circuits of the respective nonvolatile memory devices at each set time, as the temperature information.

5. The memory system according to claim 3, wherein the controller
includes a plurality of counters for counting the numbers of commands transferred to the respective nonvolatile memory devices, and
calculates temperatures expected in the respective nonvolatile memory devices, as the temperature information, by checking values of the respective counters at each set time, and then initializes the counters.

6. The memory system according to claim 3, wherein the controller
calculates an average temperature of the nonvolatile memory devices by checking the temperatures of the respective nonvolatile memory devices, compares the calculated average temperature with the temperatures of the respective nonvolatile memory devices, and determines the rankings of the respective nonvolatile memory devices depending on a result of the comparison.

7. The memory system according to claim 6, wherein the controller,
in the case where the temperatures for at least two memory devices among the nonvolatile memory devices are within a set temperature range,
checks the parameter information for the at least two memory devices, and adjusts rankings depending on a result of the check.

8. The memory system according to claim 7, wherein the controller,
as a result of checking the parameter information for the at least two memory devices,
increases a ranking of a memory device of the at least two memory devices which is relatively larger in the number of free blocks, is relatively smaller in the number of bad blocks, is relatively smaller in a value of a read reclaim count accumulated based on the set time, is relatively smaller in a size of write data accumulated based on the set time or is relatively longer in a length of an idle time based on the set time.

9. The memory system according to claim 3, wherein the controller
schedules the execution sequence of the commands stored in the command queue such that a command corresponding to a nonvolatile memory device of which ranking is relatively high among the nonvolatile memory devices is executed before a command corresponding to a nonvolatile memory device of which ranking is relatively low among the nonvolatile memory devices.

10. The memory system according to claim 3, wherein the controller
schedules an execution sequence of write commands among the commands stored in the command queue such that a write command corresponding to a nonvolatile memory device of which ranking is relatively high among the nonvolatile memory devices is executed before a write command corresponding to an nonvolatile memory device of which ranking is relatively low among the nonvolatile memory devices.

11. A method for operating a memory system including a plurality of nonvolatile memory devices and a command queue for storing a set number of commands received from a host, the method comprising:
generating temperature information by checking temperatures of the respective nonvolatile memory devices at each set time, using a controller;
calculating rankings of the respective nonvolatile memory devices by using the temperature information, using the controller; and
scheduling an execution sequence of the commands stored in the command queue, based on the calculated rankings of the nonvolatile memory devices, using the controller.

12. The method according to claim 11, wherein the set time is any among
a first time requested from the host,
a second time repeated with a set time interval,
a third time repeated each time a size of data transmitted by the controller to, or received by the controller from, the host is a set size,
a fourth time repeated each time commands received by the controller from the host is a set number, and
a fifth time at which an idle time of the controller is maintained for at least a set time.

13. The method according to claim 12, wherein
each of the nonvolatile memory devices includes a plurality of memory blocks,
the method further comprising managing, as parameter information, at least one of information on the number of free blocks among the memory blocks in each of the nonvolatile memory devices, information on the number of bad blocks among the memory blocks, information on a read reclaim count accumulated based on the set time, information on a size of write data accumulated based on the set time, and information on a length of an idle time based on the set time, and
wherein the calculating of the rankings of the respective nonvolatile memory devices is performed by using the temperature information and the parameter information.

14. The method according to claim 13, wherein
the respective nonvolatile memory devices include temperature measurement circuits for physically measuring temperatures thereof, and
wherein the generating of the temperature information comprises receiving temperatures measured by the temperature measurement circuits of the respective nonvolatile memory devices at each set time, as the temperature information.

15. The method according to claim 13, further comprising:
counting, by a plurality of counters, the numbers of commands transferred to the respective nonvolatile memory devices, and
wherein the generating of the temperature information comprises calculating temperatures expected in the respective nonvolatile memory devices, as the temperature information, by checking values of the respective counters at each set time, and then initializing the counters.

16. The method according to claim 13, wherein the calculating of the rankings comprises:
calculating an average temperature of the nonvolatile memory devices by checking the generated temperatures; and
adjusting a first ranking by comparing the average temperature calculated with the temperatures of the respective nonvolatile memory devices, and determining the rankings of the respective nonvolatile memory devices based on a result of the comparison.

17. The method according to claim 16, wherein the calculating of the rankings comprises:
adjusting a second ranking, in the case where at least two among the generated temperatures are within a set temperature range, by checking the parameter information for at least two nonvolatile memory devices corresponding to the at least two generated temperatures, and adjusting rankings depending on a result of the check.

18. The method according to claim 17, wherein the adjusting of the second ranking comprises:
in the case where at least two among the generated temperatures are within a set temperature range, checking the parameter information for at least two nonvolatile memory devices corresponding to the at least two generated temperatures; and
increasing a ranking of a memory device of the at least two memory devices which is relatively larger in the number of free blocks, relatively smaller in the number of bad blocks, relatively smaller in a value of a read reclaim count accumulated based on the set time, relatively smaller in a size of write data accumulated based on the set time or being relatively longer in a length of an idle time based on the set time.

19. The method according to claim 13, wherein the scheduling of the execution sequence of the commands comprises
scheduling the execution sequence of the commands stored in the command queue such that a command corresponding to a nonvolatile memory device of which ranking is relatively high among the nonvolatile memory devices is executed before a command corresponding to a nonvolatile memory device of which ranking is relatively low among the nonvolatile memory devices.

20. The method according to claim 13, wherein the scheduling of the execution sequence of the commands comprises
scheduling an execution sequence of write commands among the commands stored in the command queue such that a write command corresponding to a nonvolatile memory device of which ranking is relatively high among the nonvolatile memory devices is executed before a write command corresponding to a nonvolatile memory device of which ranking is relatively low among the nonvolatile memory devices.
